(19) United States
(12) Patent Application Publication
(10) Pub. No.: US 2014/0317999 A1
(43) Pub. Date: Oct. 30, 2014

(54) USE OF AMINES IN RECOVERY OF ACTIVE OILS

(71) Applicant: Board of Regents, The University of Texas System, Austin, TX (US)

(72) Inventors: Upali P. Weerasooriya, Austin, TX (US); Gary A. Pope, Cedar Park, TX (US)

(73) Assignee: Board of Regents, The University of Texas System, Austin, TX (US)

(21) Appl. No.: 14/261,205

(22) Filed: Apr. 24, 2014

Related U.S. Application Data
(60) Provisional application No. 61/815,619, filed on Apr. 24, 2013.

(51) Int. Cl. C09K 8/86; E21B 43/16

(52) U.S. Cl. CPC C09K 8/86; E21B 43/16
USPC 44/301; 507/244; 166/310

(57) ABSTRACT

Provided herein, inter alia, are methods and compositions useful for heavy crude oil recovery. The emulsion compositions and non-surfactant aqueous compositions provided herein may be particularly useful for the recovery of heavy crude oils under a broad range of reservoir conditions (e.g. high to low temperatures, high to low salinity, highly viscous oils).

### CROSS-REFERENCE TO RELATED APPLICATIONS

This application claims the benefit of U.S. Provisional Application No. 61/815,619 filed Apr. 24, 2013, which is hereby incorporated in its entirety and for all purposes.

### BACKGROUND OF THE INVENTION

Enhanced Oil Recovery (abbreviated EOR) refers to techniques for increasing the amount of unrefined petroleum, or crude oil that may be extracted from an oil reservoir (e.g. an oil field). Using EOR, 40-60% of the reservoir's original oil can typically be extracted compared with only 20-40% using primary and secondary recovery (e.g. by water injection or natural gas injection). Enhanced oil recovery may also be referred to as improved oil recovery or tertiary recovery (as opposed to primary and secondary recovery).

Enhanced oil recovery may be achieved by a variety of methods including miscible gas injection (which includes carbon dioxide flooding), chemical injection (which includes polymer flooding, alkaline flooding and surfactant flooding), microbial injection, or thermal recovery (which includes cyclic steam, steam flooding, and fire flooding). The injection of various chemicals, usually as dilute aqueous solutions, has been used to improve oil recovery. Injection of alkaline or caustic solutions into reservoirs with oil that has organic acids or acid precursors naturally occurring in the oil will result in the production of soap (i.e. in situ generated soap) that may lower the interfacial tension enough to increase production. Injection of a dilute solution of a water soluble polymer to increase the viscosity of the injected water can increase the amount of oil recovered in some formations. Dilute solutions of surfactants such as petroleum sulfonates may be injected to lower the interfacial tension or capillary pressure that impedes oil droplets from moving through a reservoir. Special formulations of oil, water and surfactant microemulsions have also proven useful. Such formulations may further include co-solvent compounds which have the capability of increasing the solubility of the solutes in the presence of oil and are able to decrease the viscosity of an emulsion. Application of these methods is usually limited by the cost of the chemicals and their adsorption and loss onto the rock of the oil containing formation.

Some unrefined petroleum contains carboxylic acids having, for example, C₁₁ to C₂₀ alkyl chains, including napthenic acid mixtures. The recovery of such “reactive” oils may be performed using alkali (e.g. NaOH or Na₂CO₃) in a surfactant composition. The alkali reacts with the acid in the reactive oil to form soap in situ. These in situ generated soaps serve as an additional source of surfactants enabling the use of much lower level of surfactants initially added to affect enhanced oil recovery (EOR). However, when the available water supply is hard, the added alkali causes precipitation of cations, such as Ca⁺² or Mg⁺². In order to prevent such precipitation an expensive chelant such as EDTA may be required in the surfactant composition. Alternatively, expensive water softening processes may be used.

Therefore, there is a need in the art for cost effective methods for enhanced oil recovery using chemical injection. Provided herein are methods and compositions addressing these and other needs in the art

### BRIEF SUMMARY OF THE INVENTION

The emulsion compositions and non-surfactant aqueous compositions provided herein include a co-solvent (e.g. an alkylamine or a compound of formula (I), (II), or (III)) and water and may be particularly useful for heavy crude oil recovery under a broad range of reservoir conditions (e.g. high to low temperatures, high to low salinity, highly viscous oils). Compared to existing surfactant compositions used in the art, the non-surfactant aqueous compositions according to the embodiments provided herein may be highly versatile and cost effective.

In one aspect, an emulsion composition including a heavy crude oil, water and a co-solvent is provided. The co-solvent is an alkylamine or a compound having the formula:

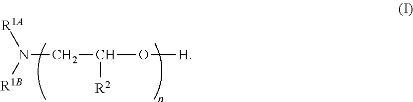

In formula (I) R^{1A} and R^{1B} are independently hydrogen, unsubstituted C₁-C₈ alkyl, unsubstituted cycloalkyl, unsubstituted heterocycloalkyl, unsubstituted aryl, unsubstituted heteroaryl, C₁-C₆ alkylamine or

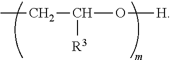

R² and R³ are independently hydrogen or unsubstituted C₁-C₂ alkyl. The symbol n is an integer from 1 to 30. The symbol m is an integer from 1 to 30 and the emulsion composition provided herein is within a petroleum reservoir.

In another aspect, a non-surfactant aqueous composition including water and a co-solvent is provided. The co-solvent is an alkylamine or a compound having the formula:

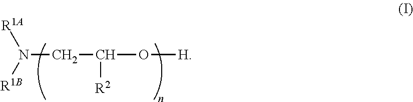

In formula (I) R^{1A} and R^{1B} are independently hydrogen, unsubstituted C₁-C₈ alkyl, unsubstituted cycloalkyl, unsubstituted heterocycloalkyl, unsubstituted aryl, unsubstituted heteroaryl, C₁-C₆ alkylamine or

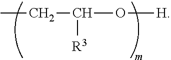

R² and R³ are independently hydrogen or unsubstituted C₁-C₂ alkyl. The symbol n is an integer from 1 to 30 and m is an integer from 1 to 30.

In another aspect, a method of displacing an unrefined petroleum material including a heavy crude oil, wherein the unrefined petroleum material is in contact with a solid material is provided. The method includes contacting an unrefined petroleum material including a heavy crude oil with an non-surfactant aqueous composition provided herein including embodiments thereof, wherein the unrefined petroleum material is in contact with a solid material. The unrefined petroleum material is allowed to separate from the solid material thereby displacing the unrefined petroleum material in contact with the solid material.

In another aspect, a method of converting an unrefined petroleum acid into a surfactant is provided. The method includes contacting a petroleum material with the non-surfactant aqueous composition provided herein including embodiments thereof, thereby forming an emulsion in contact with the petroleum material. An unrefined petroleum acid within the unrefined petroleum material is allowed to enter into the emulsion, thereby converting the unrefined petroleum acid into a surfactant.

### BRIEF DESCRIPTION OF THE DRAWINGS

FIG. 1. Phase behavior activity plot of 2% TETA with an active oil at 100° C. at day 10.

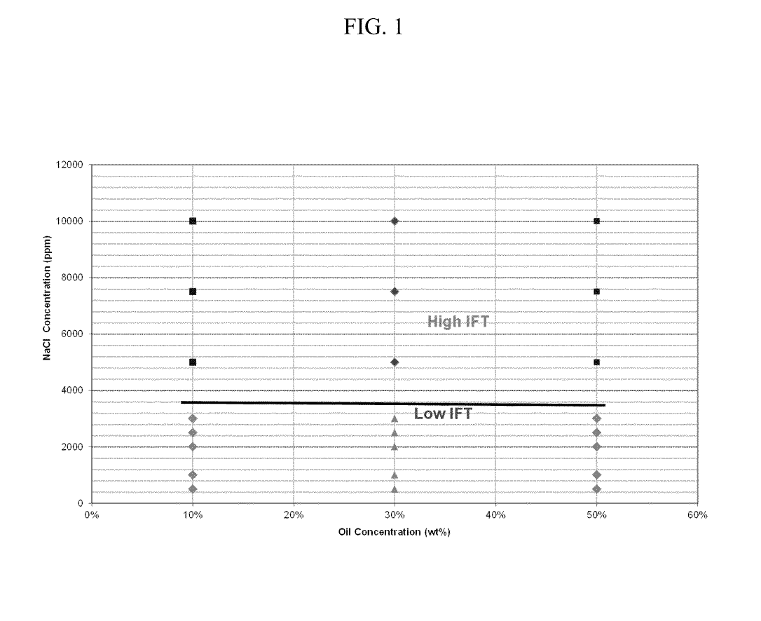

### DETAILED DESCRIPTION OF THE INVENTION

### I. Definitions

The abbreviations used herein have their conventional meaning within the chemical and biological arts.

Where substituent groups are specified by their conventional chemical formulae, written from left to right, they equally encompass the chemically identical substituents that would result from writing the structure from right to left, e.g., —CH₂O— is equivalent to —OCH₂—.

The term “alkyl,” by itself or as part of another substituent, means, unless otherwise stated, a straight (i.e. unbranched) or branched chain which may be fully saturated, mono- or polyunsaturated and can include di- and multivalent radicals, having the number of carbon atoms designated (i.e. C₁-C₁₀ means one to ten carbons). Examples of saturated hydrocarbon radicals include, but are not limited to, groups such as methyl, ethyl, n-propyl, isopropyl, n-butyl, t-butyl, isobutyl, sec-butyl, homologs and isomers of, for example, n-pentyl, n-hexyl, n-heptyl, n-octyl, and the like. An unsaturated alkyl group is one having one or more double bonds or triple bonds. Examples of unsaturated alkyl groups include, but are not limited to, vinyl, 2-propenyl, crotyl, 2-isopentenyl, 2-(butadienyl), 2,4-pentadienyl, 3-(1,4-pentadienyl), ethynyl, 1- and 3-propynyl, 3-butynyl, and the higher homologs and isomers. Alkyl groups which are limited to hydrocarbon groups are termed “homoalkyl”. An alkoxy is an alkyl attached to the remainder of the molecule via an oxygen linker (—O—).

The term “alkylene” by itself or as part of another substituent means a divalent radical derived from an alkyl, as exemplified, but not limited, by —CH₂CH₂CH₂CH₂—, and further includes those groups described below as “heteroalkylene.” Typically, an alkyl (or alkylene) group will have from 1 to 24 carbon atoms, with those groups having 10 or fewer carbon atoms being preferred in the present invention. A “lower alkyl” or “lower alkylene” is a shorter chain alkyl or alkylene group, generally having eight or fewer carbon atoms.

The term “heteroalkyl,” by itself or in combination with another term, means, unless otherwise stated, a stable straight or branched chain or combinations thereof, consisting of at least one carbon atom and at least one heteroatom selected from the group consisting of O, N, P, Si and S, and wherein the nitrogen and sulfur atoms may optionally be oxidized and the nitrogen heteroatom may optionally be quaternized. The heteroatom(s) O, N, P and S and Si may be placed at any interior position of the heteroalkyl group or at the position at which the alkyl group is attached to the remainder of the molecule. Examples include, but are not limited to, —CH₂—CH₂—O—CH₃, —CH₂—CH₂—NH—CH₃, —CH₂—CH₂—N(CH₃)—CH₃, —CH₂—S—CH₂—CH₃, —CH₂—CH₂, —S(O)—CH₃, —CH₂—CH₂—S(O)₂—CH₃, —CH═CH—O—CH₃, —Si(CH₃)₃, —CH₂—CH═N—OCH₃, —CH═CH—N(CH₃)—CH₃, —O—CH₃, —O—CH₂, —CH₃, and —CN. Up to two heteroatoms may be consecutive, such as, for example, —CH₂—NH—OCH₃. Similarly, the term “heteroalkylene” by itself or as part of another substituent means a divalent radical derived from heteroalkyl, as exemplified, but not limited by, —CH₂—CH_{2-S}—CH₂—CH₂— and —CH₂—S—CH₂—CH₂—NH—CH₂—. For heteroalkylene groups, heteroatoms can also occupy either or both of the chain termini (e.g., alkyleneoxy, alkylenedioxy, alkyleneamino, alkylenediamino, and the like). Still further, for alkylene and heteroalkylene linking groups, no orientation of the linking group is implied by the direction in which the formula of the linking group is written. For example, the formula —C(O)₂R′— represents both —C(O)₂R′— and —R′C(O)₂—.

The terms “cycloalkyl” and “heterocycloalkyl,” by themselves or in combination with other terms, represent, unless otherwise stated, cyclic versions of “alkyl” and “heteroalkyl”, respectively. Additionally, for heterocycloalkyl, a heteroatom can occupy the position at which the heterocycle is attached to the remainder of the molecule. Examples of cycloalkyl include, but are not limited to, cyclopropyl, cyclobutyl, cyclopentyl, cyclohexyl, 1-cyclohexenyl, 3-cyclohexenyl, cycloheptyl, and the like. Examples of heterocycloalkyl include, but are not limited to, 1-(1,2,5,6-tetrahydropyridyl), 1-piperidinyl, 2-piperidinyl, 3-piperidinyl, 4-morpholinyl, 3-morpholinyl, tetrahydrofuran-2-yl, tetrahydrofuran-3-yl, tetrahydrothien-2-yl, tetrahydrothien-3-yl, 1-piperazinyl, 2-piperazinyl, and the like. A “cycloalkylene” and a “heterocycloalkylene,” alone or as part of another substituent means a divalent radical derived from a cycloalkyl and heterocycloalkyl, respectively.

The term “aryl” means, unless otherwise stated, a polyunsaturated, aromatic, hydrocarbon substituent which can be a single ring or multiple rings (preferably from 1 to 3 rings) which are fused together (i.e. a fused ring aryl) or linked covalently. A fused ring aryl refers to multiple rings fused together wherein at least one of the fused rings is an aryl ring. The term “heteroaryl” refers to aryl groups (or rings) that contain from one to four heteroatoms selected from N, O, and S, wherein the nitrogen and sulfur atoms are optionally oxidized, and the nitrogen atom(s) are optionally quaternized. Thus, the term “heteroaryl” includes fused ring heteroaryl groups (i.e. multiple rings fused together wherein at least one of the fused rings is a heteroaromatic ring). A 5,6-fused ring heteroarylene refers to two rings fused together, wherein one ring has 5 members and the other ring has 6 members, and wherein at least one ring is a heteroaryl ring. Likewise, a 6,6-fused ring heteroarylene refers to two rings fused together, wherein one ring has 6 members and the other ring has 6 members, and wherein at least one ring is a heteroaryl ring. And a 6,5-fused ring heteroarylene refers to two rings fused together, wherein one ring has 6 members and the other ring has 5 members, and wherein at least one ring is a heteroaryl ring. A heteroaryl group can be attached to the remainder of the molecule through a carbon or heteroatom. Non-limiting examples of aryl and heteroaryl groups include phenyl, 1-naphthyl, 2-naphthyl, 4-biphenyl, 1-pyrrolyl, 2-pyrrolyl, 3-pyrrolyl, 3-pyrazolyl, 2-imidazolyl, 4-imidazolyl, pyrazinyl, 2-oxazolyl, 4-oxazolyl, 2-phenyl-4-oxazolyl, 5-oxazolyl, 3-isoxazolyl, 4-isoxazolyl, 5-isoxazolyl, 2-thiazolyl, 4-thiazolyl, 5-thiazolyl, 2-furyl, 3-furyl, 2-thienyl, 3-thienyl, 2-pyridyl, 3-pyridyl, 4-pyridyl, 2-pyrimidyl, 4-pyrimidyl, 5-benzothiazolyl, purinyl, 2-benzimidazolyl, 5-indolyl, 1-isoquinolyl, 5-isoquinolyl, 2-quinoxalinyl, 5-quinoxalinyl, 3-quinolyl, and 6-quinolyl. Substituents for each of the above noted aryl and heteroaryl ring systems are selected from the group of acceptable substituents described below. An “arylene” and a “heteroarylene,” alone or as part of another substituent means a divalent radical derived from an aryl and heteroaryl, respectively.

Where a substituent of a compound provided herein is “R-substituted” (e.g. R⁷-substituted), it is meant that the substituent is substituted with one or more of the named R groups (e.g. R⁷) as appropriate. In some embodiments, the substituent is substituted with only one of the named R groups.

The symbol “ [symbol] ” denotes the point of attachment of a chemical moiety to the remainder of a molecule or chemical formula.

Each R-group as provided in the formulae provided herein can appear more than once. Where an R-group appears more than once each R group can be optionally different.

The term “contacting” as used herein, refers to materials or compounds being sufficiently close in proximity to react or interact. For example, in methods of contacting a hydrocarbon material bearing formation and/or a well bore, the term “contacting” includes placing an non-surfactant aqueous composition (including for example chemical, co-solvent or polymer) within a hydrocarbon material bearing formation using any suitable manner known in the art (e.g., pumping, injecting, pouring, releasing, displacing, spotting or circulating the chemical into a well, well bore or hydrocarbon bearing formation).

The terms “unrefined petroleum” and “crude oil” are used interchangeably and in keeping with the plain ordinary usage of those terms. “Unrefined petroleum” and “crude oil” may be found in a variety of petroleum reservoirs (also referred to herein as a “reservoir,” “oil field deposit” “deposit” and the like) and in a variety of forms including oleaginous materials, oil shales (i.e. organic-rich fine-grained sedimentary rock), tar sands, light oil deposits, heavy oil deposits, and the like. “Crude oils” or “unrefined petroleums” generally refer to a mixture of naturally occurring hydrocarbons that may be refined into diesel, gasoline, heating oil, jet fuel, kerosene, and other products called fuels or petrochemicals. Crude oils or unrefined petroleums are named according to their contents and origins, and are classified according to their per unit weight (specific gravity). Heavier crudes generally yield more heat upon burning, but have lower gravity as defined by the American Petroleum Institute (API) and market price in comparison to light (or sweet) crude oils. Crude oil may also be characterized by its Equivalent Alkane Carbon Number (EACN).

Crude oils vary widely in appearance and viscosity from field to field. They range in color, odor, and in the properties they contain. While all crude oils are mostly hydrocarbons, the differences in properties, especially the variation in molecular structure, determine whether a crude oil is more or less easy to produce, pipeline, and refine. The variations may even influence its suitability for certain products and the quality of those products. Crude oils are roughly classified into three groups, according to the nature of the hydrocarbons they contain. (i) Paraffin based crude oils contain higher molecular weight paraffins, which are solid at room temperature, but little or no asphaltic (bituminous) matter. They can produce high-grade lubricating oils. (ii) Asphaltene based crude oils contain large proportions of asphaltic matter, and little or no paraffin. Some are predominantly naphthenes and so yield lubricating oils that are sensitive to temperature changes than the paraffin-based crudes. (iii) Mixed based crude oils contain both paraffin and naphthenes, as well as aromatic hydrocarbons. Most crude oils fit this latter category.

“Heavy crude oils” as provided herein are crude oils, with an API gravity of less than 20. The heavy crude oils may have a viscosity greater than 100 cP. In some embodiments, the heavy crude oil has a viscosity of at least 100 cP. In other embodiments, the heavy crude oil has a viscosity of at least 1,000 cP. In other embodiments, the heavy crude oil has a viscosity of at least 10,000 cP. In other embodiments, the heavy crude oil has a viscosity of at least 100,000 cP. In other embodiments, the heavy crude oil has a viscosity of at least 1,000,000 cP.

“Reactive” or “active” heavy crude oil as referred to herein is crude oil containing natural organic acidic components (also referred to herein as unrefined petroleum acid) or their precursors such as esters or lactones. These active heavy crude oils can generate soaps (carboxylates) when reacted with alkali or other basic agents (e.g. a basic co-solvent as provided herein). More terms used interchangeably for heavy crude oil throughout this disclosure are hydrocarbon material or active petroleum material. An “oil bank” or “oil cut” as referred to herein, is the heavy crude oil that does not contain the injected chemicals and is pushed by the injected fluid during an enhanced oil recovery process. A “nonactive oil,” as used herein, refers to an oil that is not substantially reactive or crude oil not containing significant amounts of natural organic acidic components or their precursors such as esters or lactones such that significant amounts of soaps are generated when reacted with alkali or other basic agents (e.g. a basic co-solvent as provided herein). A nonactive oil as referred to herein includes oils having an acid number of less than 0.5 mg KOH/g of oil.

“Unrefined petroleum acids” as referred to herein are carboxylic acids contained in active petroleum material (reactive heavy crude oil). The unrefined petroleum acids contain C₁₁ to C₂₀ alkyl chains, including napthenic acid mixtures. The recovery of such “reactive” oils may be performed using alkali (e.g. NaOH or Na₂CO₃) or other basic agents (e.g. a basic co-solvent as provided herein) in a non-surfactant composition. The alkali or other basic agent (e.g. a basic co-solvent as provided herein) reacts with the acid in the reactive oil to form soap in situ. These in situ generated soaps serve as a source of surfactants enabling efficient oil recovery from the reservoir.

The term “polymer” refers to a molecule having a structure that essentially includes the multiple repetitions of units derived, actually or conceptually, from molecules of low relative molecular mass. In some embodiments, the polymer is an oligomer.

The term “bonded” refers to having at least one of covalent bonding, hydrogen bonding, ionic bonding, Van Der Waals interactions, pi interactions, London forces or electrostatic interactions.

The term “productivity” as applied to a petroleum or oil well refers to the capacity of a well to produce hydrocarbons (e.g. unrefined petroleum); that is, the ratio of the hydrocarbon flow rate to the pressure drop, where the pressure drop is the difference between the average reservoir pressure and the flowing bottom hole well pressure (i.e., flow per unit of driving force).

The term “oil solubilization ratio” is defined as the volume of oil solubilized divided by the volume of surfactant in microemulsion. All the surfactant is presumed to be in the microemulsion phase. The oil solubilization ratio is applied for Winsor type I and type III behavior. The volume of oil solubilized is found by reading the change between initial aqueous level and excess oil (top) interface level. The oil solubilization ratio is calculated as follows:

$${σ}_{O} = \frac{{V}_{O}}{{V}_{S}} ,$$

wherein
σₒ=oil solubilization ratio;
Vₒ=volume of oil solubilized;
Vₛ=volume of surfactant.

The term “water solubilization ratio” is defined as the volume of water solubilized divided by the volume of surfactant in microemulsion. All the surfactant is presumed to be in the microemulsion phase. The water solubilization ratio is applied for Winsor type III and type II behavior. The volume of water solubilized is found by reading the change between initial aqueous level and excess water (bottom) interface level. The water solubilization parameter is calculated as follows:

$${σ}_{W} = \frac{{W}_{w}}{{V}_{S}} ,$$

wherein
σ_{w}=water solubilization ratio;
V_{w}=volume of water solubilized.

The optimum solubilization ratio occurs where the oil and water solubilization ratios are equal. The coarse nature of phase behavior screening often does not include a data point at optimum, so the solubilization ratio curves are drawn for the oil and water solubilization ratio data and the intersection of these two curves is defined as the optimum. The following is true for the optimum solubilization ratio:

### σ_{O}=σ_{W}=σ*;

σ*=optimum solubilization ratio.

The term “solubility” or “solubilization” in general refers to the property of a solute, which can be a solid, liquid or gas, to dissolve in a solid, liquid or gaseous solvent thereby forming a homogenous solution of the solute in the solvent. Solubility occurs under dynamic equilibrium, which means that solubility results from the simultaneous and opposing processes of dissolution and phase joining (e.g. precipitation of solids). The solubility equilibrium occurs when the two processes proceed at a constant rate. The solubility of a given solute in a given solvent typically depends on temperature. For many solids dissolved in liquid water, the solubility increases with temperature. In liquid water at high temperatures, the solubility of ionic solutes tends to decrease due to the change of properties and structure of liquid water. In more particular, solubility and solubilization as referred to herein is the property of oil to dissolve in water and vice versa.

“Viscosity” refers to a fluid's internal resistance to flow or being deformed by shear or tensile stress. In other words, viscosity may be defined as thickness or internal friction of a liquid. Thus, water is “thin”, having a lower viscosity, while oil is “thick”, having a higher viscosity. More generally, the less viscous a fluid is, the greater its ease of fluidity.

The term “salinity” as used herein, refers to concentration of salt dissolved in a aqueous phases. Examples for such salts are without limitation, sodium chloride, magnesium and calcium sulfates, and bicarbonates. In more particular, the term salinity as it pertains to the present invention refers to the concentration of salts in brine and surfactant solutions.

The term “aqueous solution,” “aqueous composition” or “aqueous formulation” refers to a solution having water as a solvent. The term “emulsion,” “emulsion solution,” “emulsion composition” or “emulsion formulation” refers to a mixture of two or more liquids which are normally immiscible. A non-limiting example for an emulsion is a mixture of oil and water.

An “alkali agent” is used according to its conventional meaning and includes basic, ionic salts of alkali metals or alkaline earth metals. Alkali agents as provided herein are typically capable of reacting with an unrefined petroleum acid (e.g. the acid in crude oil (reactive oil)) to form soap (a surfactant salt of a fatty acid) in situ. These in situ generated soaps serve as a source of surfactants causing a reduction of the interfacial tension of the oil in water emulsion, thereby reducing the viscosity of the emulsion. Examples of alkali agents useful for the provided invention include, but are not limited to, sodium hydroxide, sodium carbonate, sodium silicate, sodium metaborate, and EDTA tetrasodium salt.

A “co-solvent” refers to a compound having the ability to increase the solubility of a solute (e.g., in situ generated soap, a polymer, an alkali agent) in the presence of an unrefined petroleum acid. In some embodiments, the compounds provided herein (e.g., an alkylamine or a compound of formula (I), (II), or (III)) including embodiments thereof are basic co-solvents. A “basic co-solvent” refers to a compound capable of accepting protons (e.g. compounds including a basic nitrogen atom) and reacting with an unrefined petroleum acid (e.g. the acid in crude oil (reactive oil)) to form soap (a surfactant salt of a fatty acid), for example, in situ.

The term “alkylamine” is used according to its ordinary meaning and refers to a heteroalkane compound composed of one or more nitrogen heteroatoms, carbon atoms (e.g. C₁-C₆ alkyl or alkylene groups) and hydrogen atoms wherein at least one nitrogen atom is basic. In some embodiments, the alkylamine is a secondary amine (e.g., diisopropylamine). A “secondary amine” as provided herein is used according to its ordinary meaning and refers to an organic compound wherein the nitrogen atom is bound to a hydrogen atom and two non-hydrogen substituents, wherein the two non-hydrogen substituents are independently aryl or alkyl. In other embodiments, the alkylamine is an alkylpolyamine. An “alkylpolyamine” as provided herein is used according to its ordinary meaning and refers to an alkylamine having a plurality of nitrogen heteroatoms (e.g. NH₂ or NH group). Non limiting examples of alkylpolyamines are dimethylaminopropylamine (DMAPA), triethylenetetramine (TETA), and diethylenetriamine (DETA). The alkylamine or alkylpolyamine as provided herein may include saturated C₁-C₆ alkyl or alkylene bound to another substituent (e.g., R^{1A} or R^{1B}).

The term “arylamine” is used according to its ordinary meaning and refers to a saturated 5 to 10 membered aryl ring substituted with at least one NH₂ group. A non-limiting example of an arylamine useful for the compositions provided herein is aniline.

An “alkylamine alkoxylate” as provided herein is used according to its ordinary meaning and refers to an alkylamine in which a nitrogen heteroatom is bonded to a hydrophilic moiety including an alcohol and/or an alkoxy portion. The term “alcohol” is used according to its ordinary meaning and refers to an organic compound containing an —OH group attached to a carbon atom. The term “alkoxy” refers to an alkyl (e.g. C₁-C₄ alkyl) group singularly bonded to oxygen. The alkoxy may be an ethoxy (—CH₂—CH₂—O—), a propoxy (—CH₂—CH(methyl)-O—) or a butoxy (—CH₂—CH(ethyl)-O—) group.

A “microemulsion” as referred to herein is a thermodynamically stable mixture of oil and water that may also include additional components such as the co-solvents provided herein including embodiments thereof, electrolytes, alkali and polymers. In contrast, a “macroemulsion” as referred to herein is a thermodynamically unstable mixture of oil and water that may also include additional components. The emulsion composition provided herein may be an oil-in-water emulsion, wherein the in situ generated soap aggregates (e.g. micelles) include a hydrophilic portion contacting the aqueous phase of the emulsion and a lipophilic portion contacting the oil phase of the emulsion. Thus, in some embodiments, the in situ generated soap forms part of the aqueous phase of the emulsion. And in other embodiments, the in situ generated soap forms part of the oil phase of the emulsion. In yet another embodiment, the in situ generated soap forms part of an interface between the aqueous phase and the oil phase of the emulsion.

### II. Compositions

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not limit the scope of the invention.

Provided herein, inter alia, are emulsion compositions and aqueous compositions including an alkylamine or a compound of formula (I), (II) or (III), and methods of using the same for a variety of applications including enhanced oil recovery. The compositions provided herein may be used with broad oil concentrations, at a wide range of salinities, at high reservoir temperatures and over a broad pH range. In some embodiments, the compositions provided herein represent a cost effective alternative to commonly used EOR surfactant compositions and are particularly useful for the recovery of heavy crude oils. The compounds included in the compositions provided herein are typically capable of reacting with an unrefined petroleum acid (e.g. the acid in crude oil (reactive oil)) to form soap (a surfactant salt of a fatty acid) in situ. These in situ generated soaps may serve as surfactants causing a reduction of the interfacial tension of the oil in water emulsion, thereby reducing the viscosity of the emulsion (e.g. microemulsion). In some embodiments, the interfacial tension between oil and brine is surprisingly low using the compositions provided herein even in the absence of an alkali agent. Further, the compounds included in the compositions provided herein (e.g., an alkylamine or a compound of formula (I), (II). or (III)) may improve the solubility of other components present in the non-surfactant composition (e.g. alkali agent, polymer).

In one aspect, an emulsion composition including a heavy crude oil, water and a co-solvent is provided. The co-solvent is an alkylamine or a compound having the formula:

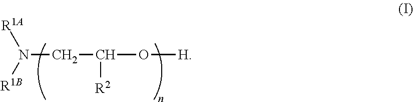

In formula (I) R^{1A} and R^{1B} are independently hydrogen, unsubstituted C₁-C₈ alkyl, unsubstituted cycloalkyl, unsubstituted heterocycloalkyl, unsubstituted aryl, unsubstituted heteroaryl, C₁-C₆ alkylamine or

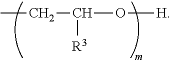

R² and R³ are independently hydrogen or unsubstituted C₁-C₂ alkyl. The symbol n is an integer from 1 to 30. The symbol m is an integer from 1 to 30.

The emulsion compositions provided herein are typically within a petroleum reservoir. Thus, the emulsion compositions provided herein are typically not within a transport vessel (e.g. an oil pipeline). A “transport vessel” as used herein, refers to a container used for transporting oil, typically large amounts of oil (e.g. at least hundreds of gallons, at least thousands of gallons, at least millions of gallons or at least billions of gallons). A transport vessel includes a storage vessel contained within a petroleum tanker (oil tankers), barge, truck or a train. A transport vessel also includes an petroleum pipeline (oil pipeline).

In some embodiments, the symbol n is an integer from 1-30. In some embodiments, the symbol n is an integer from 1-28. In other embodiments, the symbol n is an integer from 1-26. In some embodiments, the symbol n is an integer from 1-24. In some embodiments, the symbol n is an integer from 1-22. In some embodiments, the symbol n is an integer from 1-20. In some embodiments, the symbol n is an integer from 1-18. In some embodiments, the symbol n is an integer from 1-16. In some embodiments, the symbol n is an integer from 1-14. In some embodiments, the symbol n is an integer from 1-12. In some embodiments, the symbol n is an integer from 1-10. In some embodiments, the symbol n is an integer from 1-8. In some embodiments, the symbol n is an integer from 1-6. In some embodiments, the symbol n is an integer from 1-4. In some embodiments, the symbol n is an integer from 1-3. In some embodiment, the symbol n is 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30. In one embodiment, the symbol n is 3. In other embodiments, the symbol n is 1. In one embodiment, the symbol n is 6.

In some related embodiments, R² is hydrogen and n is as defined in an embodiment above (e.g., n is at least 1, or at least 10). Thus, in some embodiments, R² is hydrogen and n is 1. In other embodiments, R² is hydrogen and n is 3.

In some embodiments, the symbol m is an integer from 1-30. In some embodiments, the symbol m is an integer from 1-28. In other embodiments, the symbol m is an integer from 1-26. In some embodiments, the symbol m is an integer from 1-24. In some embodiments, the symbol m is an integer from 1-22. In some embodiments, the symbol m is an integer from 1-20. In some embodiments, the symbol m is an integer from 1-18. In some embodiments, the symbol m is an integer from 1-16. In some embodiments, the symbol m is an integer from 1-14. In some embodiments, the symbol m is an integer from 1-12. In some embodiments, the symbol m is an integer from 1-10. In some embodiments, the symbol m is an integer from 1-8. In some embodiments, the symbol m is an integer from 1-6. In some embodiments, the symbol m is an integer from 1-4. In some embodiments, the symbol m is an integer from 1-3. In some embodiment, the symbol m is 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30. In one embodiment, the symbol m is 3. In other embodiments, the symbol m is 1. In one embodiment, the symbol m is 6.

In some related embodiments, R³ is hydrogen and m is as defined in an embodiment above (e.g., n is at least 1, or at least 10). Thus, in some embodiments, R³ is hydrogen and m is 1. In other embodiments, R³ is hydrogen and m is 3.

As provided herein R^{1A} and R^{1B} may be independently hydrogen, unsubstituted C₁-C₈ (e.g., C₁-C₄) alkyl, unsubstituted C₃-C₆ (e.g., C₆) cycloalkyl, unsubstituted 3 to 8 membered (e.g., 6 membered) heterocycloalkyl, C₅-C₈ (e.g., C₆) unsubstituted aryl, unsubstituted 5 to 8 membered (e.g., 5 to 6-membered) heteroaryl, C₁-C₆ (e.g. C₂-C₄) alkylamine or

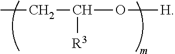

In some embodiments, R^{1A} and R^{1B} are independently unsubstituted C₁-C₈ alkyl. In other embodiments, R^{1A} and R^{1B} are independently unsubstituted C₁-C₆ alkyl. In other embodiments, R^{1A} and R^{1B} are independently unsubstituted C₁-C₄ alkyl. In some embodiments, R^{1A} and R^{1B} are unsubstituted C₃ alkyl. In some embodiments, the number of total carbon atoms within R^{1A} and R^{1B} combined does not exceed 8.

In some embodiments, R^{1A} and R^{1B} are independently branched or linear unsubstituted C₁-C₈ alkyl. In other embodiments, R^{1A} and R^{1B} are independently branched or linear unsubstituted C₁-C₆ alkyl. In other embodiments, R^{1A} and R^{1B} are independently branched or linear unsubstituted C₁-C₄ alkyl. In some embodiments, R^{1A} and R^{1B} are independently branched or linear unsubstituted C₃ alkyl. In some embodiments, R^{1A} and R^{1B} are independently linear unsubstituted C₁-C₈ alkyl. In other embodiments, R^{1A} and R^{1B} are independently branched unsubstituted C₁-C₈ alkyl. In some embodiments, R^{1A} and R^{1B} are independently linear unsubstituted C₁-C₆ alkyl. In other embodiments, R^{1A} and R^{1B} are independently branched unsubstituted C₁-C₆ alkyl. In some embodiments, R^{1A} and R^{1B} are independently linear unsubstituted C₁-C₄ alkyl. In other embodiments, R^{1A} and R^{1B} are independently branched unsubstituted C₁-C₄ alkyl. In some embodiments, R^{1A} and R^{1B} are linear unsubstituted C₃ alkyl. In other embodiments, R^{1A} and R^{1B} are branched unsubstituted C₃ alkyl. In some embodiments, R^{1A} and R^{1B} are unsubstituted isopropyl.

As provided herein R^{1A} and R^{1B} may be independently hydrogen or C₁-C₆ (e.g., C₁-C₄) alkylamine. In some embodiments, R^{1A} and R^{1B} are independently hydrogen or C₁-C₆ alkylamine. In other embodiments, R^{1A} and R^{1B} are independently hydrogen or C₂-C₆ alkylamine. In some embodiments, R^{1A} and R^{1B} are independently hydrogen or C₃-C₆ alkylamine. In other embodiments, R^{1A} and R^{1B} are independently hydrogen or C₄-C₆ alkylamine. In some embodiments, R^{1A} and R^{1B} are independently hydrogen or C₄ alkylamine. In other embodiments, R^{1A} and R^{1B} are independently hydrogen or C₅ alkylamine. In some embodiments, R^{1A} and R^{1B} are independently hydrogen or C₆ alkylamine.

In some embodiments, R^{1A} and R^{1B} are independently hydrogen or branched or linear C₁-C₆ alkylamine. In other embodiments, R^{1A} and R^{1B} are independently hydrogen or branched or linear C₂-C₆ alkylamine. In some embodiments, R^{1A} and R^{1B} are independently hydrogen or branched or linear C₃-C₆ alkylamine. In other embodiments, R^{1A} and R^{1B} are independently hydrogen or branched or linear C₄-C₆ alkylamine. In some embodiments, R^{1A} and R^{1B} are independently hydrogen or branched or linear C₄ alkylamine. In other embodiments, R^{1A} and R^{1B} are independently hydrogen or branched or linear C₅ alkylamine. In some embodiments, R^{1A} and R^{1B} are independently hydrogen or branched or linear C₆ alkylamine.

In some embodiments, R^{1A} and R^{1B} are independently hydrogen or linear C₁-C₆ alkylamine. In other embodiments, R^{1A} and R^{1B} are independently hydrogen or linear C₂-C₆ alkylamine. In some embodiments, R^{1A} and R^{1B} are independently hydrogen or linear C₃-C₆ alkylamine. In other embodiments, R^{1A} and R^{1B} are independently hydrogen or linear C₄-C₆ alkylamine. In some embodiments, R^{1A} and R^{1B} are independently hydrogen or linear C₄ alkylamine. In other embodiments, R^{1A} and R^{1B} are independently hydrogen or linear C₅ alkylamine. In some embodiments, R^{1A} and R^{1B} are independently hydrogen or linear C₆ alkylamine. In some embodiments, R^{1A} and R^{1B} are independently hydrogen or branched C₁-C₆ alkylamine. In other embodiments, R^{1A} and R^{1B} are independently hydrogen or branched C₂-C₆ alkylamine. In some embodiments, R^{1A} and R^{1B} are independently hydrogen or branched C₃-C₆ alkylamine. In other embodiments, R^{1A} and R^{1B} are independently hydrogen or branched C₄-C₆ alkylamine. In some embodiments, R^{1A} and R^{1B} are independently hydrogen or branched C₄ alkylamine. In other embodiments, R^{1A} and R^{1B} are independently hydrogen or branched C₅ alkylamine. In some embodiments, R^{1A} and R^{1B} are independently hydrogen or branched C₆ alkylamine.

In some embodiments, R^{1A} is hydrogen and R^{1B} is C₄-C₆ alkylamine. In other embodiments, R^{1A} is hydrogen and R^{1B} is branched or linear C₄-C₆ alkylamine. In some embodiments, R^{1A} is hydrogen and R^{1B} is linear C₄-C₆ alkylamine. In other embodiments, R^{1A} is hydrogen and R^{1B} is branched C₄-C₆ alkylamine. In some embodiments, R^{1A} is hydrogen and R^{1B} is C₄ alkylamine. In some embodiments, R^{1A} is hydrogen and R^{1B} is linear C₄ alkylamine. In other embodiments, R^{1A} is hydrogen and R^{1B} is C₅ alkylamine. In other embodiments, R^{1A} is hydrogen and R^{1B} is linear C₅ alkylamine. In other embodiments, R^{1A} is hydrogen and R^{1B} is C₆ alkylamine. In other embodiments, R^{1A} is hydrogen and R^{1B} is linear C₆ alkylamine.

R^{1A} and R^{1B} may be independently C₁-C₆ (e.g., C₁-C₄) alkylamine. In some embodiments, R^{1A} and R^{1B} are independently C₁-C₆ alkylamine. In other embodiments, R^{1A} and R^{1B} are independently C₂-C₆ alkylamine. In other embodiments, R^{1A} and R^{1B} are independently C₃-C₆ alkylamine. In other embodiments, R^{1A} and R^{1B} are independently C₄-C₆ alkylamine. In some embodiments, R^{1A} and R^{1B} are independently branched or linear C₁-C₆ alkylamine. In other embodiments, R^{1A} and R^{1B} are independently branched or linear C₂-C₆ alkylamine. In other embodiments, R^{1A} and R^{1B} are independently branched or linear C₃-C₆ alkylamine. In other embodiments, R^{1A} and R^{1B} are independently branched or linear C₄-C₆ alkylamine. In some embodiments, R^{1A} and R^{1B} are independently linear C₁-C₆ alkylamine. In other embodiments, R^{1A} and R^{1B} are independently linear C₂-C₆ alkylamine. In other embodiments, R^{1A} and R^{1B} are independently linear C₃-C₆ alkylamine. In other embodiments, R^{1A} and R^{1B} are independently linear C₄-C₆ alkylamine. In some embodiments, R^{1A} and R^{1B} are independently branched C₁-C₆ alkylamine. In other embodiments, R^{1A} and R^{1B} are independently branched C₂-C₆ alkylamine. In other embodiments, R^{1A} and R^{1B} are independently branched C₃-C₆ alkylamine. In other embodiments, R^{1A} and R^{1B} are independently branched C₄-C₆ alkylamine. In some embodiments, R^{1A} and R^{1B} are independently C₂ alkylamine or C₄ alkylamine. In some embodiments, R^{1A} and R^{1B} are C₂ alkylamine.

As described herein R^{1A} and R^{1B} may be an alkylpolyamine. Thus, in some embodiments, the alkylamine is an alkylpolyamine. In some embodiments, R^{1A} and R^{1B} are independently C₁-C₆ alkylpolyamine. In other embodiments, R^{1A} and R^{1B} are independently C₂-C₆ alkylpolyamine. In other embodiments, R^{1A} and R^{1B} are independently C₃-C₆ alkylpolyamine. In other embodiments, R^{1A} and R^{1B} are independently C₄-C₆ alkylpolyamine. In some embodiments, R^{1A} and R^{1B} are independently branched or linear C₁-C₆ alkylpolyamine. In other embodiments, R^{1A} and R^{1B} are independently branched or linear C₂-C₆ alkylpolyamine. In other embodiments, R^{1A} and R^{1B} are independently branched or linear C₃-C₆ alkylpolyamine. In other embodiments, R^{1A} and R^{1B} are independently branched or linear C₄-C₆ alkylpolyamine. In some embodiments, R^{1A} and R^{1B} are independently linear C₁-C₆ alkylpolyamine. In other embodiments, R^{1A} and R^{1B} are independently linear C₂-C₆ alkylpolyamine. In other embodiments, R^{1A} and R^{1B} are independently linear C₃-C₆ alkylpolyamine. In other embodiments, R^{1A} and R^{1B} are independently linear C₄-C₆ alkylpolyamine. In some embodiments, R^{1A} and R^{1B} are independently branched C₁-C₆ alkylpolyamine. In other embodiments, R^{1A} and R^{1B} are independently branched C₂-C₆ alkylpolyamine. In other embodiments, R^{1A} and R^{1B} are independently branched C₃-C₆ alkylpolyamine. In other embodiments, R^{1A} and R^{1B} are independently branched C₄-C₆ alkylpolyamine. In some embodiments, R^{1A} and R^{1B} are independently C₂ alkylamine or C₄ alkylpolyamine.

In some embodiments, R^{1A} and R^{1B} are independently hydrogen or C₁-C₆ alkylamine. In other embodiments, R^{1A} and R^{1B} are C₁-C₆ alkylamine. In some embodiments, R^{1A} and R^{1B} are C₁-C₆ alkylpolyamine. In the embodiments provided herein R^{1A} and R^{1B} may have the structure of formula:

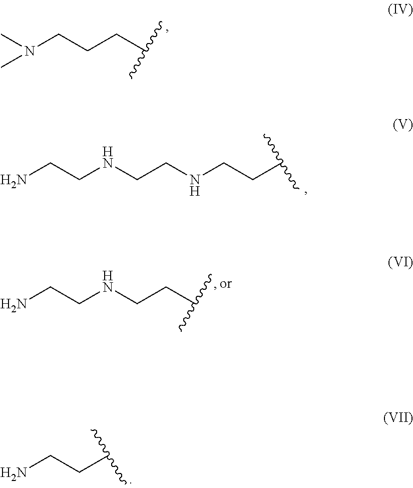

In some embodiments, R^{1A} is hydrogen and R^{1B} has the structure of formula

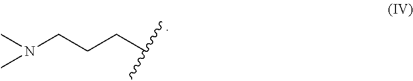 [SMILES: *CCCN(C)C]

In other embodiments, R^{1A} is hydrogen and R^{1B} has the structure of formula

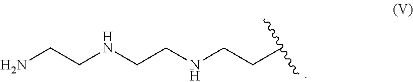 [SMILES: *CCNCCNCCN]

In other embodiments, R^{1A} is hydrogen and R^{1B} has the structure of formula

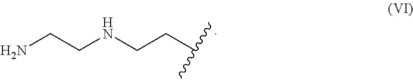 [SMILES: *CCNCCN]

In some embodiments, R^{1A} has the structure of formula

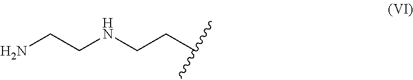 [SMILES: *CCNCCN]

and R^{1B} has the structure of formula

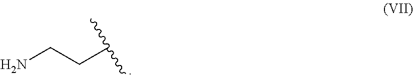 [SMILES: *CCN]

In other embodiments, R^{1A} and R^{1B} have the structure of formula

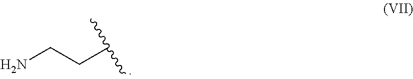 [SMILES: *CCN]

As provided herein R^{1A} and R^{1B} may be independently hydrogen, unsubstituted C₃-C₆ (e.g., C₆) cycloalkyl or C₅-C₈ (e.g., C₆) unsubstituted aryl. Thus, in some embodiments, R^{1A} is hydrogen and R^{1B} is unsubstituted (e.g., C₃-C₆) cycloalkyl. In some embodiments, R^{1B} is unsubstituted 6 membered cycloalkyl. In other embodiments, R^{1A} is hydrogen and R^{1B} is (e.g., C₅-C₈) unsubstituted aryl. In some embodiments, R^{1B} is phenyl.

As provided herein R² and R³ may be independently hydrogen or unsubstituted C₁-C₂ alkyl. Thus, in some embodiments, R² and R³ are independently hydrogen, methyl or ethyl. In some embodiments, where multiple R² substituents are present and at least two R² substituents are different, R² substituents with the fewest number of carbons are present to the side of the compound of formula (I), (II), or (III) bound to the hydrogen atom. In this embodiment, the compound of formula (I), (II), or (III) will be increasingly hydrophilic in progressing from the nitrogen to the side of the compound of formula (I), (II), or (III) bound to the hydrogen atom. The term “side of the compound of formula (I), (II), or (III) bound to the hydrogen atom” refers to the side of the compound indicated by asterisk in the below structures:

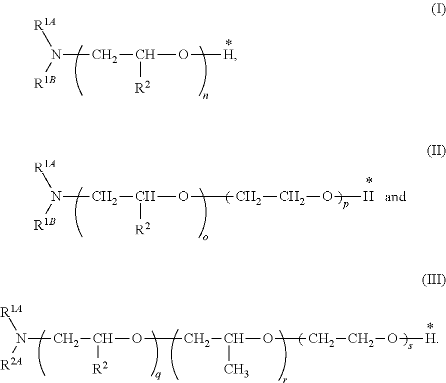

In some embodiments, the compound has the formula:

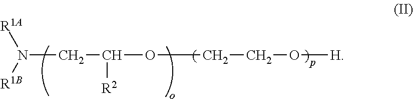

In formula (II) R^{1A} and R^{1B} are defined as above (e.g. hydrogen, C₃ alkyl, or C₁-C₆ alkylamine), R² is methyl or ethyl, o is an integer from 0 to 15 and p is an integer from 1 to 10. In some embodiments, R² is hydrogen, o is 0 and p is an integer from 1 to 6.

In some embodiments, o is 0 to 15. In some related embodiments, o is 0 to 12. In some related embodiments, o is 0 to 10. In some related embodiments, o is 0 to 8. In some related embodiments, o is 0 to 6. In some related embodiments, o is 0 to 4. In some related embodiments, o is 0 to 2. In still further related embodiments, o is 0. In some further related embodiment, p is 1 to 10. In some further related embodiment, p is 1 to 8. In some further related embodiment, p is 1 to 6. In some further related embodiment, p is 1 to 4. In some further related embodiment, p is 1 to 2. In still some further related embodiment, p is more than 1. In some further embodiment, p is 6. R^{1A}, R^{1B} and R² may be any of the embodiments described above (e.g., R^{1A} and R^{1B} maybe isopropyl, R² maybe hydrogen or unsubstituted C₁-C₂ alkyl). Thus, in some embodiment, R^{1A} and R^{1B} are isopropyl, o is 0 and p is 3.

In some embodiments, o is 1 to 15. In some related embodiments, o is 1 to 12. In some related embodiments, o is 1 to 10. In some related embodiments, o is 1 to 8. In some related embodiments, o is 1 to 6. In some related embodiments, o is 1 to 4. In some related embodiments, o is 1 to 2. In some further related embodiment, p is 1 to 10. In some further related embodiment, p is 1 to 8. In some further related embodiment, p is 1 to 6. In some further related embodiment, p is 1 to 4. In some further related embodiment, p is 1 to 2. In still some further related embodiment, p is more than 1. R^{1A}, R^{1B} and R² may be any of the embodiments described above (e.g., R^{1A} and R^{1B} maybe isopropyl, R² maybe hydrogen or unsubstituted C₁-C₂ alkyl).

In some embodiments, o is 2 to 15. In some related embodiments, o is 2 to 12. In some related embodiments, o is 2 to 10. In some related embodiments, o is 2 to 8. In some related embodiments, o is 2 to 6. In some related embodiments, o is 2 to 4. In some further related embodiment, p is 1 to 10. In some further related embodiment, p is 1 to 8. In some further related embodiment, p is 1 to 6. In some further related embodiment, p is 1 to 4. In some further related embodiment, p is 1 to 2. In still some further related embodiment, p is more than 1. R^{1A}, R^{1B} and R² may be any of the embodiments described above (e.g., R^{1A} and R^{1B} maybe isopropyl, R² maybe hydrogen or unsubstituted C₁-C₂ alkyl).

In some embodiments, o is 4 to 15. In some related embodiments, o is 4 to 12. In some related embodiments, o is 4 to 10. In some related embodiments, o is 4 to 8. In some related embodiments, o is 4 to 6. In some further related embodiment, p is 1 to 10. In some further related embodiment, p is 1 to 8. In some further related embodiment, p is 1 to 6. In some further related embodiment, p is 1 to 4. In some further related embodiment, p is 1 to 2. In still some further related embodiment, p is more than 1 R^{1A}, R^{1B} and R² may be any of the embodiments described above (e.g., R^{1A} and R^{1B} maybe isopropyl, R² maybe hydrogen or unsubstituted C₁-C₂ alkyl).

In some embodiments, o is 6 to 15. In some related embodiments, o is 6 to 12. In some related embodiments, o is 6 to 10. In some related embodiments, o is 6 to 8. In some further related embodiment, p is 1 to 10. In some further related embodiment, p is 1 to 8. In some further related embodiment, p is 1 to 6. In some further related embodiment, p is 1 to 4. In some further related embodiment, p is 1 to 2. In still some further related embodiment, p is more than 1. R^{1A}, R^{1B} and R² may be any of the embodiments described above (e.g., R^{1A} and R^{1B} maybe isopropyl, R² maybe hydrogen or unsubstituted C₁-C₂ alkyl).

In some embodiments, o is 8 to 15. In some related embodiments, o is 8 to 12. In some related embodiments, o is 8 to 10. In some further related embodiment, p is 1 to 10. In some further related embodiment, p is 1 to 8. In some further related embodiment, p is 1 to 6. In some further related embodiment, p is 1 to 4. In some further related embodiment, p is 1 to 2. In still some further related embodiment, p is more than 1. R^{1A}, R^{1B} and R² may be any of the embodiments described above (e.g., R^{1A} and R^{1B} maybe isopropyl, R² maybe hydrogen or unsubstituted C₁-C₂ alkyl).

In some embodiments, o is 10 to 15. In some related embodiments, o is 10 to 12. In some further related embodiment, p is 1 to 10. In some further related embodiment, p is 1 to 8. In some further related embodiment, p is 1 to 6. In some further related embodiment, p is 1 to 4. In some further related embodiment, p is 1 to 2. In still some further related embodiment, p is more than 1. R^{1A}, R^{1B} and R² may be any of the embodiments described above (e.g., R^{1A} and R^{1B} maybe isopropyl, R² maybe hydrogen or unsubstituted C₁-C₂ alkyl).

In some embodiments, o is 12 to 15. In some further related embodiment, p is 1 to 10. In some further related embodiment, p is 1 to 8. In some further related embodiment, p is 1 to 6. In some further related embodiment, p is 1 to 4. In some further related embodiment, p is 1 to 2. In still some further related embodiment, p is more than 1. R^{1A}, R^{1B} and R² may be any of the embodiments described above (e.g., R^{1A} and R^{1B} maybe isopropyl, R² maybe hydrogen or unsubstituted C₁-C₂ alkyl).

In other embodiments, the compound has the formula:

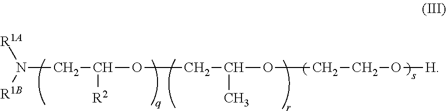

In formula (III) R² is ethyl, q is an integer from 0 to 10, r is an integer from 0 to 10 and s is an integer from 1 to 10.

In some embodiment, q is 0 to 10. In some related embodiment, q is 1 to 10. In some related embodiment, q is 2 to 10. In some related embodiment, q is 3 to 10. In some related embodiment, q is 4 to 10. In some related embodiment, q is 5 to 10. In some related embodiment, q is 6 to 10. In some related embodiment, q is 7 to 10. In some related embodiment, q is 8 to 10. In some related embodiment, q is 9 to 10. Moreover, in still further related embodiments, q is 0. In some further related embodiment, r is 0 to 10. In some further related embodiment, r is 1 to 10. In some further related embodiment, r is 2 to 10. In some further related embodiment, r is 3 to 10. In some further related embodiment, r is 4 to 10. In some further related embodiment, r is 5 to 10. In some further related embodiment, r is 6 to 10. In some further related embodiment, r is 7 to 10. In some further related embodiment, r is 8 to 10. In some further related embodiment, r is 9 to 10. Moreover, in still further related embodiments, r is 0. In still some further embodiment, s is 1 to 10. In still some further embodiment, s is 2 to 10. In still some further embodiment, s is 3 to 10. In still some further embodiment, s is 4 to 10. In still some further embodiment, s is 5 to 10. In still some further embodiment, s is 6 to 10. In still some further embodiment, s is 7 to 10. In still some further embodiment, s is 8 to 10. In still some further embodiment, s is 9 to 10. R^{1A}, R^{1B} and R² may be any of the embodiments described above (e.g., R^{1A} and R^{1B} maybe isopropyl, R² maybe hydrogen or unsubstituted C₁-C₂ alkyl).

In some embodiment, q is 0 to 9. In some related embodiment, q is 1 to 9. In some related embodiment, q is 2 to 9. In some related embodiment, q is 3 to 9. In some related embodiment, q is 4 to 9. In some related embodiment, q is 5 to 9. In some related embodiment,

q is 6 to 9. In some related embodiment, q is 7 to 9. In some related embodiment, q is 8 to 9. Moreover, in still further related embodiments, q is 0. In some further related embodiment, r is 0 to 10. In some further related embodiment, r is 1 to 10. In some further related embodiment, r is 2 to 10. In some further related embodiment, r is 3 to 10. In some further related embodiment, r is 4 to 10. In some further related embodiment, r is 5 to 10. In some further related embodiment,

r is 6 to 10. In some further related embodiment, r is 7 to 10. In some further related embodiment, r is 8 to 10. In some further related embodiment, r is 9 to 10. Moreover, in still further related embodiments, r is 0. In still some further embodiment, s is 1 to 10. In still some further embodiment, s is 2 to 10. In still some further embodiment, s is 3 to 10. In still some further embodiment, s is 4 to 10. In still some further embodiment, s is 5 to 10. In still some further embodiment, s is 6 to 10. In still some further embodiment, s is 7 to 10. In still some further embodiment, s is 8 to 10. In still some further embodiment, s is 9 to 10. R^{1A}, R^{1B} and R² may be any of the embodiments described above (e.g., R^{1A} and R^{1B} maybe isopropyl, R² maybe hydrogen or unsubstituted C₁-C₂ alkyl).

In some embodiment, q is 0 to 8. In some related embodiment, q is 1 to 8. In some related embodiment, q is 2 to 8. In some related embodiment, q is 3 to 8. In some related embodiment, q is 4 to 8. In some related embodiment, q is 5 to 8. In some related embodiment,

q is 6 to 8. In some related embodiment, q is 7 to 8. Moreover, in still further related embodiments, q is 0. In some further related embodiment, r is 0 to 10. In some further related embodiment, r is 1 to 10. In some further related embodiment, r is 2 to 10. In some further related embodiment, r is 3 to 10. In some further related embodiment, r is 4 to 10. In some further related embodiment, r is 5 to 10. In some further related embodiment, r is 6 to 10. In some further related embodiment, r is 7 to 10. In some further related embodiment, r is 8 to 10. In some further related embodiment, r is 9 to 10. Moreover, in still further related embodiments, r is 0. In still some further embodiment, s is 1 to 10. In still some further embodiment, s is 2 to 10. In still some further embodiment, s is 3 to 10. In still some further embodiment, s is 4 to 10. In still some further embodiment, s is 5 to 10. In still some further embodiment, s is 6 to 10. In still some further embodiment, s is 7 to 10. In still some further embodiment, s is 8 to 10. In still some further embodiment, s is 9 to 10. R^{1A}, R^{1B} and R² may be any of the embodiments described above (e.g., R^{1A} and R^{1B} maybe isopropyl, R² maybe hydrogen or unsubstituted C₁-C₂ alkyl).

In some embodiment, q is 0 to 7. In some related embodiment, q is 1 to 7. In some related embodiment, q is 2 to 7. In some related embodiment, q is 3 to 7. In some related embodiment, q is 4 to 7. In some related embodiment, q is 5 to 7. In some related embodiment, q is 6 to 7. Moreover, in still further related embodiments, q is 0. In some further related embodiment, r is 0 to 10. In some further related embodiment, r is 1 to 10. In some further related embodiment, r is 2 to 10. In some further related embodiment, r is 3 to 10. In some further related embodiment, r is 4 to 10. In some further related embodiment, r is 5 to 10. In some further related embodiment, r is 6 to 10. In some further related embodiment, r is 7 to 10. In some further related embodiment, r is 8 to 10. In some further related embodiment, r is 9 to 10. Moreover, in still further related embodiments, r is 0. In still some further embodiment, s is 1 to 10. In still some further embodiment, s is 2 to 10. In still some further embodiment, s is 3 to 10. In still some further embodiment, s is 4 to 10. In still some further embodiment, s is 5 to 10. In still some further embodiment, s is 6 to 10. In still some further embodiment, s is 7 to 10. In still some further embodiment, s is 8 to 10. In still some further embodiment, s is 9 to 10. R^{1A}, R^{1B} and R² may be any of the embodiments described above (e.g., R^{1A} and R^{1B} maybe isopropyl, R² maybe hydrogen or unsubstituted C₁-C₂ alkyl).

In some embodiment, q is 0 to 6. In some related embodiment, q is 1 to 6. In some related embodiment, q is 2 to 6. In some related embodiment, q is 3 to 6. In some related embodiment, q is 4 to 6. In some related embodiment, q is 5 to 6. Moreover, in still further related embodiments, q is 0. In some further related embodiment, r is 0 to 10. In some further related embodiment, r is 1 to 10. In some further related embodiment, r is 2 to 10. In some further related embodiment, r is 3 to 10. In some further related embodiment, r is 4 to 10. In some further related embodiment, r is 5 to 10. In some further related embodiment, r is 6 to 10. In some further related embodiment, r is 7 to 10. In some further related embodiment, r is 8 to 10. In some further related embodiment, r is 9 to 10. Moreover, in still further related embodiments, r is 0. In still some further embodiment, s is 1 to 10. In still some further embodiment, s is 2 to 10. In still some further embodiment, s is 3 to 10. In still some further embodiment, s is 4 to 10. In still some further embodiment, s is 5 to 10. In still some further embodiment, s is 6 to 10. In still some further embodiment, s is 7 to 10. In still some further embodiment, s is 8 to 10. In still some further embodiment, s is 9 to 10. R^{1A}, R^{1B} and R² may be any of the embodiments described above (e.g., R^{1A} and R^{1B} maybe isopropyl, R² maybe hydrogen or unsubstituted C₁-C₂ alkyl).

In some embodiment, q is 0 to 5. In some related embodiment, q is 1 to 5. In some related embodiment, q is 2 to 5. In some related embodiment, q is 3 to 5. In some related embodiment, q is 4 to 5. Moreover, in still further related embodiments, q is 0. In some further related embodiment, r is 0 to 10. In some further related embodiment, r is 1 to 10. In some further related embodiment, r is 2 to 10. In some further related embodiment, r is 3 to 10. In some further related embodiment, r is 4 to 10. In some further related embodiment, r is 5 to 10. In some further related embodiment, r is 6 to 10. In some further related embodiment, r is 7 to 10. In some further related embodiment, r is 8 to 10. In some further related embodiment, r is 9 to 10. Moreover, in still further related embodiments, r is 0. In still some further embodiment, s is 1 to 10. In still some further embodiment, s is 2 to 10. In still some further embodiment, s is 3 to 10. In still some further embodiment, s is 4 to 10. In still some further embodiment, s is 5 to

10. In still some further embodiment, s is 6 to 10. In still some further embodiment, s is 7 to 10. In still some further embodiment, s is 8 to 10. In still some further embodiment, s is 9 to 10. R^{1A}, R^{1B} and R² may be any of the embodiments described above (e.g., R^{1A} and R^{1B} maybe isopropyl, R² maybe hydrogen or unsubstituted C₁-C₂ alkyl).

In some embodiment, q is 0 to 4. In some related embodiment, q is 1 to 4. In some related embodiment, q is 2 to 4. In some related embodiment, q is 3 to 4. Moreover, in still further related embodiments, q is 0. In some further related embodiment, r is 0 to 10. In some further related embodiment, r is 1 to 10. In some further related embodiment, r is 2 to 10. In some further related embodiment, r is 3 to 10. In some further related embodiment, r is 4 to 10. In some further related embodiment, r is 5 to 10. In some further related embodiment, r is 6 to 10. In some further related embodiment, r is 7 to 10. In some further related embodiment, r is 8 to 10. In some further related embodiment, r is 9 to 10. Moreover, in still further related embodiments, r is 0. In still some further embodiment, s is 1 to 10. In still some further embodiment, s is 2 to 10. In still some further embodiment, s is 3 to 10. In still some further embodiment, s is 4 to 10. In still some further embodiment, s is 5 to 10. In still some further embodiment, s is 6 to 10. In still some further embodiment, s is 7 to 10. In still some further embodiment, s is 8 to 10. In still some further embodiment, s is 9 to 10. R^{1A}, R^{1B} and R² may be any of the embodiments described above (e.g., R^{1A} and R^{1B} maybe isopropyl, R² maybe hydrogen or unsubstituted C₁-C₂ alkyl).

In some embodiment, q is 0 to 3. In some related embodiment, q is 1 to 3. In some related embodiment, q is 2 to 3. Moreover, in still further related embodiments, q is 0. In some further related embodiment, r is 0 to 10. In some further related embodiment, r is 1 to 10. In some further related embodiment, r is 2 to 10. In some further related embodiment, r is 3 to 10.

In some further related embodiment, r is 4 to 10. In some further related embodiment, r is 5 to 10. In some further related embodiment, r is 6 to 10. In some further related embodiment, r is 7 to 10. In some further related embodiment, r is 8 to 10. In some further related embodiment, r is 9 to 10. Moreover, in still further related embodiments, r is 0. In still some further embodiment, s is 1 to 10. In still some further embodiment, s is 2 to 10. In still some further embodiment, s is 3 to 10. In still some further embodiment, s is 4 to 10. In still some further embodiment, s is 5 to 10. In still some further embodiment, s is 6 to 10. In still some further embodiment, s is 7 to 10. In still some further embodiment, s is 8 to 10. In still some further embodiment, s is 9 to 10. R¹, R^{1B} and R² may be any of the embodiments described above (e.g., R^{1A} and R^{1B} maybe isopropyl, R² maybe hydrogen or unsubstituted C₁-C₂ alkyl).

In some embodiment, q is 0 to 2. In some related embodiment, q is 1 to 2. Moreover, in still further related embodiments, q is 0. In some further related embodiment, r is 0 to 10. In some further related embodiment, r is 1 to 10. In some further related embodiment, r is 2 to 10. In some further related embodiment, r is 3 to 10. In some further related embodiment, r is 4 to 10. In some further related embodiment, r is 5 to 10. In some further related embodiment, r is 6 to 10. In some further related embodiment, r is 7 to 10. In some further related embodiment, r is 8 to 10. In some further related embodiment, r is 9 to 10. Moreover, in still further related embodiments, r is 0. In still some further embodiment, s is 1 to 10. In still some further embodiment, s is 2 to 10. In still some further embodiment, s is 3 to 10. In still some further embodiment, s is 4 to 10. In still some further embodiment, s is 5 to 10. In still some further embodiment, s is 6 to 10. In still some further embodiment, s is 7 to 10. In still some further embodiment, s is 8 to 10. In still some further embodiment, s is 9 to 10 R^{1A}, R^{1B} and R² may be any of the embodiments described above (e.g., R^{1A} and R^{1B} maybe isopropyl, R² maybe hydrogen or unsubstituted C₁-C₂ alkyl).

In some embodiments of the compound of formula (I), or embodiments thereof provided herein, where R^{1A} and R^{1B} are isopropyl, and R² is hydrogen, the symbol n is 1 or 3. In other embodiments, where R^{1A} is hydrogen, R^{1B} has the structure of formula (IV) and R² is hydrogen, the symbol n is 1 or 3. In some embodiments, where R^{1A} is hydrogen, R^{1B} has the structure of formula (V) and R² is hydrogen, the symbol n is 1 or 3. In some embodiments, where R^{1A} is hydrogen, R^{1B} has the structure of formula (VI) and R² is hydrogen, the symbol n is 1 or 3. In some embodiments, where R^{1A} has the formula of structure (VI), R^{1B} has the structure of formula (VII) and R² is hydrogen, the symbol n is 1 or 3. In some embodiments, where R^{1A} and R^{1B} have the formula of structure (VII) and R² is hydrogen, the symbol n is 1 or 3. In other embodiments, where R^{1A} is hydrogen, R^{1B} is phenyl and R² is hydrogen, the symbol n is 1 or 3. In other embodiments, where R^{1A} is hydrogen, R^{1B} is 6 membered cycloalkyl and R² is hydrogen, the symbol n is 1 or 3.

In some embodiments, the co-solvent is a compound having the formula (I). In some embodiments, R^{1A} and R^{1B} are isopropyl, R² is hydrogen, and the symbol n is 1. In some related embodiments, the co-solvent is present at about 2% (w/w). The compound of formula (I), wherein R^{1A} and R^{1B} are isopropyl, R² is hydrogen, and the symbol n is 1 may be referred to herein as DIPA-1EO. In some embodiments, R^{1A} and R^{1B} are isopropyl, R² is hydrogen, and the symbol n is 3. In some related embodiments, the co-solvent is present at about 0.5% (w/w). The compound of formula (I), wherein R^{1A} and R^{1B} are isopropyl, R² is hydrogen, and the symbol n is 3 may be referred to herein as DIPA-3EO.

In other embodiments, the co-solvent is an alkylamine. In some embodiments, the alkylamine is diisopropylamine. In other embodiments, the alkylamine is an alkylpolyamine. In some embodiments, the alkylpolyamine is dimethylaminopropylamine, triethylenetetramine or diethylenetriamine. In some embodiments, the alkylpolyamine is dimethylaminopropylamine. In other embodiments, the alkylpolyamine is triethylenetetramine. In some embodiments, the alkylpolyamine is diethylenetriamine. Diisopropylamine refers, in the customary sense, to CAS Registry No 108-18-9 and appropriate salts thereof. Dimethylaminopropylamine refers, in the customary sense, to CAS Registry No. 109-55-7 and appropriate salts thereof. Triethylenetetramine refers, in the customary sense, to CAS Registry No. 112-24-3 and appropriate salts thereof. Diethylenetriamine refers, in the customary sense, to CAS Registry No. 111-40-0 and appropriate salts thereof. In some embodiments, the co-solvent is an arylamine. In some embodiments, the arylamine is aniline.

As described above the emulsion composition provided herein includes a heavy crude oil, water and a co-solvent, wherein the co-solvent is an alkylamine or a compound having the formula (I), (II), or (III). In one embodiment, the emulsion composition includes a heavy crude oil, water and an alkylamine, wherein the alkylamine is triethylenetetramine, present at 2% (w/w). In another embodiment, the emulsion composition includes a heavy crude oil, water and a compound of formula (I), wherein R^{1A} and R^{1B} are isopropyl, R² is hydrogen, and the symbol n is 1, present at about 2% (w/w). In another embodiment, the emulsion composition includes a heavy crude oil, water and a compound of formula (I), wherein R^{1A} and R^{1B} are isopropyl, R² is hydrogen, and the symbol n is 3, present at about 0.5% (w/w).

In one embodiment, where the emulsion composition includes a heavy crude oil, water and an alkylamine, the emulsion composition does not include a compound having the formula (I), (II) or (III). In some related embodiments, the alkylamine is triethylenetetramine. In other related embodiments, the alkylamine is dimethylaminopropylamine.

In one embodiment, where the emulsion composition includes a heavy crude oil, water and a co-solvent (e.g., an alkylamine or a compound of formula (I), (II), or (III)), the emulsion composition does not include a surfactant.

As described above, the emulsion composition provided herein may include a heavy crude oil, water and a co-solvent (e.g., an alkyamine or a compound of formula (I), (II), or (III)). In one embodiment, where the emulsion composition includes a heavy crude oil, water and a co-solvent (e.g., an alkylamine or a compound of formula (I), (II), or (III)), the emulsion composition does not include an alkali agent. In some related embodiments, the co-solvent is a basic co-solvent.

In some embodiments, the emulsion composition includes a plurality of co-solvents. Where the emulsion composition includes a plurality of different co-solvents the emulsion composition may include a first co-solvent, a second co-solvent or a third co-solvent. The first, second and third co-solvent may be independently different (e.g., a compound of formula (I) and an alkylamine; or two alkylamines having a different hydrocarbon chain length and different number of nitrogen atoms). Thus, in some embodiments, the first co-solvent is an alkylamine and the second co-solvent is a compound having the formula (I). In other embodiments, the first co-solvent is a triethylenetetramine and the second co-solvent is a compound of formula (I), wherein R^{1A} and R^{1B} are isopropyl, R² is hydrogen, and the symbol n is 1. In other embodiments, the co-solvent is an alkylamine and a compound having the formula (I).

In some embodiments, the emulsion composition further includes an alkali agent. An alkali agent as provided herein is a basic, ionic salt of an alkali metal (e.g. lithium, sodium, potassium) or alkaline earth metal element (e.g. magnesium, calcium, barium, radium). In some embodiments, the alkali agent is NaOH, KOH, LiOH, Na₂CO₃, NaHCO₃, Na-metaborate, Na silicate, Na orthosilicate, or NH₄OH. The emulsion composition may include seawater, or fresh water from an aquifer, river or lake. In some embodiments, the emulsion composition includes hard brine or soft brine. In some further embodiments, the water is soft brine. In some further embodiments, the water is hard brine. Where the emulsion composition includes soft brine, the aqueous composition may include an alkaline agent. In soft brine the alkaline agent provides for enhanced soap generation from the oils, lower surfactant adsorption to the solid material (e.g. rock) in the reservoir and increased solubility of viscosity enhancing water soluble polymers. In some embodiment, the alkali agent is present in the emulsion composition at a concentration from about 0.1% w/w to about 10% w/w.

The emulsion composition provided herein may further include a gas. Thus, in some embodiments, the emulsion composition further includes a gas. For instance, the gas may be combined with the emulsion composition to reduce its mobility by decreasing the liquid flow in the pores of the solid material (e.g. rock). In some embodiments, the gas may be supercritical carbon dioxide, nitrogen, natural gas or mixtures of these and other gases.

In one embodiment, the emulsion composition further includes a viscosity enhancing water-soluble polymer. In one embodiment, the viscosity enhancing water-soluble polymer may be a biopolymer such as xanthan gum or scleroglucan, a synthetic polymer such as polyacrylamide, hydrolyzed polyacrylamide or co-polymers of acrylamide and acrylic acid, 2-acrylamido 2-methyl propane sulfonate or N-vinyl pyrrolidone, a synthetic polymer such as polyethylene oxide, or any other high molecular weight polymer soluble in water or brine. In one embodiment, the viscosity enhancing water-soluble polymer is polyacrylamide or a co-polymer of polyacrylamide. In one embodiment, the viscosity enhancing water-soluble polymer is a partially (e.g. 20%, 25%, 30%, 35%, 40%, 45%) hydrolyzed anionic polyacrylamide. In some further embodiment, the viscosity enhancing water-soluble polymer has a molecular weight of approximately about 8×10⁶. In some other further embodiment, the viscosity enhancing water-soluble polymer has a molecular weight of approximately about 18×10⁶. Non-limiting examples of commercially available polymers useful for the invention including embodiments provided herein are Florpaam 3330S and Florpaam 3360S.

In some embodiments, the co-solvent (e.g., an alkylamine or a compound of formula (I), (II), or (III)) is present in an amount sufficient to increase the solubility of the viscosity enhancing water-soluble polymer in the emulsion composition realtive to the absence of the co-solvent. In other words, in the presence of a sufficient amount of the co-solvent, the solubility of the viscosity enhancing water-soluble polymer in the emulsion composition is higher than in the absence of the co-solvent. In other embodiments, the co-solvent is present in an amount sufficient to increase the solubility of the viscosity enhancing water-soluble polymer in the emulsion composition relative to the absence of the co-solvent. Thus, in the presence of a sufficient amount of the co-solvent the solubility of the viscosity enhancing water-soluble polymer in the emulsion composition is higher than in the absence of the co-solvent.

As described above, the heavy crude oils included in the emulsion compositions provided herein are highly viscous. In some embodiments, the heavy crude oil has a viscosity of at least 100,000 cP. In other embodiments, the heavy crude oil has a viscosity of at least 200,000 cP. In some embodiments, the heavy crude oil has a viscosity of at least 300,000 cP. In some embodiments, the heavy crude oil has a viscosity of about 1,000,000 cP.

In some embodiments, the emulsion composition is a microemulsion. A “microemulsion” as referred to herein is a thermodynamically stable mixture of oil and water that may also include additional components such as the co-solvents provided herein including embodiments thereof, electrolytes, alkali and polymers. In contrast, a “macroemulsion” as referred to herein is a thermodynamically unstable mixture of oil and water that may also include additional components. The emulsion composition provided herein may be an oil-in-water emulsion, wherein the in situ generated soap aggregates (e.g. micelles) include a hydrophilic portion contacting the aqueous phase of the emulsion and a lipophilic portion contacting the oil phase of the emulsion. Thus, in some embodiments, the in situ generated soap forms part of the aqueous phase of the emulsion. And in other embodiments, the in situ generated soap forms part of the oil phase of the emulsion. In yet another embodiment, the in situ generated soap forms part of an interface between the aqueous phase and the oil phase of the emulsion.

In some embodiments, the co-solvent provided herein including embodiments thereof (e.g., an alkylamine or a compound of formula (I), (II), or (III)) is present in an amount sufficient to decrease the viscosity of the emulsion relative to the absence of the co-solvent. Thus, in some embodiments, the viscosity of the emulsion is lower than the viscosity in the absence of the co-solvent. In some embodiments, the viscosity of the emulsion is lower than the viscosity of the heavy oil. In some embodiments, the co-solvent provided herein including embodiments thereof (e.g., an alkylamine or a compound of formula (I), (II), or (III)) is present in an amount sufficient to decrease the viscosity of the microemulsion relative to the absence of the co-solvent. In other embodiments, the microemulsion equilibrates faster in the presence of the co-solvent than in the absence of the co-solvent.

As described above the emulsion composition provided herein may include a co-solvent, wherein the co-solvent is capable of reacting with an unrefined petroleum acid (e.g. the acid in crude oil (reactive oil)) to form soap (a surfactant salt of a fatty acid) in situ. The formation of soap in situ promotes the formation of emulsions (both microemulsion and macroemulsion) providing for efficient decrease of the heavy crude oil viscosity by lowering the interfacial tension between the water and the heavy crude oil.

In some embodiments, the emulsion composition includes a co-solvent (e.g., an alkylamine or a compound of formula (I), (II), or (III)) and an alkali agent. Where the emulsion composition includes a co-solvent (e.g., an alkylamine or a compound of formula (I), (II), or (III)) and an alkali agent, the co-solvent serves as an interfacial viscosity agent when in contact with the heavy crude oil (e.g. an unrefined petroleum) within the heavy crude oil emulsion composition. An “interfacial viscosity agent” as provided herein is an agent that in the presence of an alkali agent facilitates the formation of soap in situ from carboxylic acids (e.g. endogenous carboxylic acids) contained in the unrefined oil (also referred to herein as unrefined oil acid). By contacting the alkali agent with the carboxylic acid in the crude oil (e.g. by delivering the basic agent more efficiently than water alone) the co-solvent facilitates the generation of soap in situ. The co-solvent provided herein may further allow for the formation of a microemulsion between the unrefined petroleum, the alkali agent, the co-solvent and the water. The co-solvent may decrease the interfacial viscosity and thus help promote emulsion formation and transform highly viscous macroemulsions to less viscous microemulsions. The co-solvent may further break the macroemulsions or prevent the formation of highly viscous macroemulsion entirely. In some embodiments, where the emulsion composition includes a co-solvent (e.g., an alkylamine or a compound of formula (I), (II), or (III)) and an alkali agent, the co-solvent is capable of accepting protons from the carboxylic acid in the crude oil, thereby forming a protonated co-solvent. The alkali agent may accept protons from the protonated co-solvent, thereby forming a regenerated co-solvent.

The co-solvents according to the embodiments provided herein may also be referred to herein as “co-solvents provided herein” or “the co-solvent of the present invention.” Any one or combination of a co-solvent (e.g., an alkylamine or a compound of formula (I), (II), or (III)) is useful in the methods and compositions provided herein.

The co-solvent provided herein including embodiments thereof (e.g., an alkylamine or a compound of formula (I), (II), or (III)) may be present at an amount from about 0.05% (w/v) to about 10% (w/v). Thus, in some embodiments, the co-solvent (e.g., an alkylamine or a compound of formula (I), (II), or (III)) is present from about 0.05% w/w to about 10% w/w. In some embodiments, the co-solvent is present from about 0.1% w/w to about 10% w/w. In other embodiments, the co-solvent is present from about 0.5% w/w to about 10% w/w. In some embodiments, the co-solvent is present from about 1% w/w to about 10% w/w. In other embodiments, the co-solvent is present from about 1.5% w/w to about 10% w/w. In some embodiments, the co-solvent is present from about 2% w/w to about 10% w/w. In other embodiments, the co-solvent is present from about 2.5% w/w to about 10% w/w. In some embodiments, the co-solvent is present from about 3% w/w to about 10% w/w. In other embodiments, the co-solvent is present from about 3.5% w/w to about 10% w/w. In some embodiments, the co-solvent is present from about 4% w/w to about 10% w/w. In other embodiments, the co-solvent is present from about 4.5% w/w to about 10% w/w. In some embodiments, the co-solvent is present from about 5% w/w to about 10% w/w. In other embodiments, the co-solvent is present from about 5.5% w/w to about 10% w/w. In some embodiments, the co-solvent is present from about 6% w/w to about 10% w/w. In other embodiments, the co-solvent is present from about 6.5% w/w to about 10% w/w. In some embodiments, the co-solvent is present from about 7% w/w to about 10% w/w. In other embodiments, the co-solvent is present from about 7.5% w/w to about 10% w/w. In some embodiments, the co-solvent is present from about 8% w/w to about 10% w/w. In other embodiments, the co-solvent is present from about 8.5% w/w to about 10% w/w. In some embodiments, the co-solvent is present from about 9% w/w to about 10% w/w. In other embodiments, the co-solvent is present from about 9.5% w/w to about 10% w/w. In some embodiments, the co-solvent is present at about 2% w/w. In other embodiments, the co-solvent is present at about 0.5% w/w.

The total co-solvent concentration (i.e. the total amount of all co-solvent types within the heavy crude oil emulsion compositions provided herein) may be from about 0.05% (w/w) to about 10% (w/w). Thus, in some embodiments, the total co-solvent concentration (i.e. the total amount of all co-solvent types within the heavy crude oil emulsion compositions provided herein) is from about 0.05% w/w to about 10% w/w. In some embodiments, the total co-solvent concentration is from about 0.1% w/w to about 10% w/w. In other embodiments, the total co-solvent concentration is from about 0.5% w/w to about 10% w/w. In some embodiments, the total co-solvent concentration is from about 1% w/w to about 10% w/w. In other embodiments, the total co-solvent concentration is from about 1.5% w/w to about 10% w/w. In some embodiments, the total co-solvent concentration is from about 2% w/w to about 10% w/w. In other embodiments, the total co-solvent concentration is from about 2.5% w/w to about 10% w/w. In some embodiments, the total co-solvent concentration is from about 3% w/w to about 10% w/w. In other embodiments, the total co-solvent concentration is from about 3.5% w/w to about 10% w/w. In some embodiments, the total co-solvent concentration is from about 4% w/w to about 10% w/w. In other embodiments, the total co-solvent concentration is from about 4.5% w/w to about 10% w/w. In some embodiments, the total co-solvent concentration is from about 5% w/w to about 10% w/w. In other embodiments, the total co-solvent concentration is from about 5.5% w/w to about 10% w/w. In some embodiments, the total co-solvent concentration is from about 6% w/w to about 10% w/w. In other embodiments, the total co-solvent concentration is from about 6.5% w/w to about 10% w/w. In some embodiments, the total co-solvent concentration is from about 7% w/w to about 10% w/w. In other embodiments, the total co-solvent concentration is from about 7.5% w/w to about 10% w/w. In some embodiments, the total co-solvent concentration is from about 8% w/w to about 10% w/w. In other embodiments, the total co-solvent concentration is from about 8.5% w/w to about 10% w/w. In some embodiments, the total co-solvent concentration is from about 9% w/w to about 10% w/w. In other embodiments, the total co-solvent concentration is from about 9.5% w/w to about 10% w/w.

In another aspect, a non-surfactant aqueous composition including water and a co-solvent is provided. The co-solvent is an alkylamine or a compound having the formula:

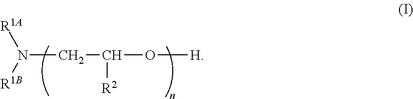

In formula (I) R^{1A} and R^{1B} are independently hydrogen, unsubstituted C₁-C₈ alkyl, unsubstituted cycloalkyl, unsubstituted heterocycloalkyl, unsubstituted aryl, unsubstituted heteroaryl, C₁-C₆ alkylamine or

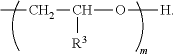

R² and R³ are independently hydrogen or unsubstituted C₁-C₂ alkyl. The symbol n is an integer from 1 to 30 and m is an integer from 1 to 30.

A “non-surfactant aqueous composition” as provided herein refers to a composition which does not include a surface active agent having an alkyl chain with more than six carbons. The non-surfactant aqueous compositions provided herein do not include large hydrophobic alkoxy carboxylates, where the hydrophobic portion has at least 8 and up to 150 carbons bound together, a hydrophilic portion (e.g. a carboxylate) and alkoxy portion including up to 210 alkoxy groups bound together, as disclosed in the international application having international application number PCT/US2011/049617. The non-surfactant aqueous composition provided herein includes water and a co-solvent as described herein including embodiments thereof (e.g., an alkylamine or a compound of formula (I), (II), or (III)). In some embodiments, the non-surfactant aqueous composition includes the components set forth in the emulsion composition provided above. Thus, in some embodiments, R^{1A} and R^{1B} are independently unsubstituted C₁-C₆ alkyl. In other embodiments, the number of total carbon atoms within R^{1A} and R^{1B} combined does not exceed 8. In some embodiments, R^{1A} and R^{1B} are independently unsubstituted C₁-C₄ alkyl. In other embodiments, R^{1A} and R^{1B} are unsubstituted isopropyl. In some embodiments, the symbol n is an integer from 1 to 10. In other embodiments, the symbol n is 1 to 6. In some embodiments, R² is hydrogen and n is 1 to 3. In some embodiments, the symbol m is an integer from 1 to 10. In other embodiments, the symbol m is 1 to 6. In some embodiments, R³ is hydrogen and m is an integer from 1 to 3.

In some embodiments, R^{1A} and R^{1B} are independently hydrogen or C₂-C₆ alkylamine. In other embodiments, R^{1A} is hydrogen and R^{1B} is C₄-C₆ alkylamine. In some embodiments, R^{1A} and R^{1B} are independently C₂-C₄ alkylamine. In other embodiments, the alkylamine is an alkylpolyamine. In some embodiments, R^{1A} is hydrogen and R^{1B} is unsubstituted cycloalkyl. In other embodiments, R^{1B} is 6 membered cycloalkyl. In some embodiments, R^{1A} is hydrogen and R^{1B} is unsubstituted aryl. In other embodiments, R^{1B} is phenyl.

In some embodiments, the compound has the formula:

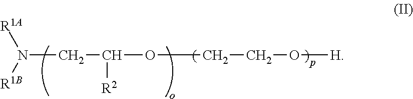

In formula (II) R² is methyl or ethyl. o is an integer from 0 to 15, and p is an integer from 1 to 10. In some embodiments, R² is hydrogen, o is 0 and p is an integer from 1 to 6.

In other embodiments, the compound has the formula:

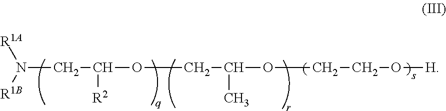

In formula (III) R² is ethyl, q is an integer from 0 to 10, r is an integer from 0 to 10, and s is an integer from 1 to 10.

In some embodiments, the alkylamine is diisopropylamine. In other embodiments, the alkylamine is an alkylpolyamine. In some embodiments, the alkylpolyamine is dimethylaminopropylamine, triethylenetetramine or diethylenetriamine.

In other embodiments, the non-surfactant aqueous composition further includes an alkali agent. In some embodiments, the alkali agent is NaOH, KOH, LiOH, Na₂CO₃, NaHCO₃, Na-metaborate, Na silicate, Na orthosilicate, Na acetate or NH₄OH. In other embodiments, the non-surfactant aqueous further includes an arylamine. In other embodiments, the arylamine is aniline. In some embodiments, the non-surfactant aqueous composition further includes a viscosity enhancing water soluble polymer. In some embodiments, the viscosity enhancing water soluble polymer is polyacrylamide or a co-polymer of polyacrylamide. In other embodiments, the non-surfactant aqueous composition further includes a gas.

As described above the non-surfactant aqueous composition provided herein includes water and a co-solvent, wherein the co-solvent is an alkylamine or a compound having the formula (I), (II), or (III). In one embodiment, the non-surfactant aqueous composition includes water and an alkylamine, wherein the alkylamine is triethylenetetramine, present at 2% (w/w). In another embodiment, the non-surfactant aqueous composition includes water and a compound of formula (I), wherein R^{1A} and R^{1B} are isopropyl, R² is hydrogen, and the symbol n is 1, present at about 2% (w/w). In another embodiment, the non-surfactant aqueous composition includes water and a compound of formula (I), wherein R^{1A} and R^{1B} are isopropyl, R² is hydrogen, and the symbol n is 3, present at about 0.5% (w/w).

As described above, the non-surfactant aqueous composition provided herein may include water and a co-solvent (e.g., an alkylamine or a compound of formula (I), (II), or (III)). In one embodiment, where the non-surfactant aqueous composition includes water and a co-solvent (e.g., an alkylamine or a compound of formula (I), (II), or (III)), the non-surfactant aqueous composition does not include an alkali agent. In some related embodiment, the co-solvent is a basic co-solvent.

In one embodiment, where the non-surfactant aqueous composition includes water and an alkylamine, the non-surfactant aqueous composition does not include a compound having the formula (I), (II) or (III). In some related embodiment, the alkylamine is triethylenetetramine. In other related embodiments, the alkylamine is dimethylaminopropylamine.

### III. Methods

In another aspect, a method of displacing an unrefined petroleum material including a heavy crude oil, wherein the unrefined petroleum material is in contact with a solid material is provided. The method includes contacting an unrefined petroleum material including a heavy crude oil with an non-surfactant aqueous composition provided herein (e.g. a non-surfactant aqueous composition including water and a co-solvent, wherein the co-solvent is an alkylamine or a compound of formula (I), (II), or (III)) including embodiments thereof, wherein the unrefined petroleum material is in contact with a solid material. The unrefined petroleum material is allowed to separate from the solid material thereby displacing the unrefined petroleum material in contact with the solid material. In some embodiments, the method further includes contacting the solid material with the non-surfactant aqueous composition. In other embodiments, the method is an enhanced oil recovery method. In some embodiments, the natural solid material is rock or regolith. In some embodiments, the regolith is soil. In some embodiments, the emulsion forms after the contacting. The emulsion thus formed may be the emulsion composition as described above. Thus, in one embodiment, where the emulsion composition includes a heavy crude oil, water and a co-solvent (e.g., an alkylamine or a compound of formula (I), (II), or (III)), the emulsion composition does not include an alkali agent. In some related embodiment, the co-solvent is a basic co-solvent.

In one embodiment, where the emulsion composition includes a heavy crude oil, water and an alkylamine, the emulsion composition does not include a compound having the formula (I), (II) or (III). In some related embodiment, the alkylamine is triethylenetetramine. In other related embodiments, the alkylamine is dimethylaminopropylamine.

In one embodiment, where the emulsion composition includes a heavy crude oil, water and a co-solvent (e.g., an alkylamine or a compound of formula (I), (II), or (III)), the emulsion composition does not include a surfactant.

In another aspect, a method of converting an unrefined petroleum acid into a surfactant is provided. The method includes contacting a petroleum material with the non-surfactant aqueous composition provided herein (e.g. a non-surfactant aqueous composition including water and a co-solvent, wherein the co-solvent is an alkylamine or a compound of formula (I), (II), or (III)) including embodiments thereof, thereby forming an emulsion in contact with the petroleum material. An unrefined petroleum acid within the unrefined petroleum material is allowed to enter into the emulsion, thereby converting the unrefined petroleum acid into a surfactant. In some embodiments, the unrefined petroleum material is in a petroleum reservoir. In other embodiments, the unrefined petroleum material includes an active oil.

### IV. Examples

### Phase Behavior Procedures

Phase Behavior Screening: Phase behavior studies have been used to characterize chemicals for EOR. There are many benefits in using phase behavior as a screening method. Phase Behavior studies are used to determine: (1) the effect of electrolytes; (2) oil solubilization and IFT reduction, (3) microemulsion densities; (4) microemulsion viscosities; (5) coalescence times; (6) optimal co-solvent/alkali agent formulations; and/or (7) optimal properties for recovering oil from cores and reservoirs.

Thermodynamically stable phases can form with oil, water and non-surfactant aqueous mixtures. In situ generated soaps form micellar structures at concentrations at or above the critical micelle concentration (CMC). The emulsion coalesces into a separate phase at the oil-water interface and is referred to as a microemulsion. A microemulsion is a surfactant-rich distinct phase consisting of in situ generated soaps, oil and water and co-solvent, alkali agent and other components. This phase is thermodynamically stable in the sense that it will return to the same phase volume at a given temperature. Some workers in the past have added additional requirements, but for the purposes of this engineering study, the only requirement will be that the microemulsion is a thermodynamically stable phase.

The phase transition is examined by keeping all variables fixed except for the scanning variable. The scan variable is changed over a series of pipettes and may include, but is not limited to, salinity, temperature, chemical (co-solvent, alcohol, electrolyte), oil, which is sometimes characterized by its equivalent alkane carbon number (EACN), and co-solvent structure, which is sometimes characterized by its hydrophilic-lipophilic balance (HLB). The phase transition was first characterized by Winsor (1954) into three regions: Type I—excess oleic phase, Type III—aqueous, microemulsion and oleic phases, and the Type II—excess aqueous phase. The phase transition boundaries and some common terminology are described as follows: Type I to III—lower critical salinity, Type III to II—upper critical salinity, oil solubilization ratio (Vo/Vs), water solubilization ratio (Vw/Vs), the solubilization value where the oil and water solubilization ratios are equal is called the Optimum Solubilization Ratio (σ*), and the electrolyte concentration where the optimum solubilization ratio occurs is referred to as the Optimal Salinity (S*). Since no surfactant is added, the only surfactant present is the in-situ generated soap. For the purpose of calculating a solubilization ratio, one can assume a value for soap level using TAN (total acid number) and an approximate molecular weight for the soap.

### Determining Interfacial Tension

Efficient use of time and lab resources can lead to valuable results when conducting phase behavior scans. A correlation between oil and water solubilization ratios and interfacial tension was suggested by Healy and Reed (1976) and a theoretical relationship was later derived by Chun Huh (1979). Lowest oil-water IFT occurs at optimum solubilization as shown by the Chun Huh theory. This is equated to an interfacial tension through the Chun Huh equation, where IFT varies with the inverse square of the solubilization ratio:

$$γ = \frac{C}{{σ}^{2}} \qquad ( 1 )$$

For most crude oils and microemulsions, C=0.3 is a good approximation. Therefore, a quick and convenient way to estimate IFT is to measure phase behavior and use the Chun-Huh equation to calculate IFT. The IFT between microemulsions and water and/or oil can be very difficult and time consuming to measure and is subject to larger errors, so using the phase behavior approach to screen hundreds of combinations of co-solvents, electrolytes, oil, and so forth is not only simpler and faster, but avoids the measurement problems and errors associated with measuring IFT especially of combinations that show complex behavior (gels and so forth) and will be screened out anyway. Once a good formulation has been identified, then it is still a good idea to measure IFT.

### Equipment

Phase behavior experiments are created with the following materials and equipment.

Mass Balance: Mass balances are used to measure chemicals for mixtures and determine initial saturation values of cores.
Water Deionizer: Deionized (DI) water is prepared for use with all the experimental solutions using a Nanopure™ filter system. This filter uses a recirculation pump and monitors the water resistivity to indicate when the ions have been removed. Water is passed through a 0.45 micron filter to eliminate undesired particles and microorganisms prior to use.
Borosilicate Pipettes: Standard 5 mL borosilicate pipettes with 0.1 mL markings are used to create phase behavior scans as well as run dilution experiments with aqueous solutions. Ends are sealed using a propane and oxygen flame.
Pipette Repeater: An Eppendorf Repeater Plus® instrument is used for most of the pipetting. This is a handheld dispenser calibrated to deliver between 25 microliter and 1 ml increments. Disposable tips are used to avoid contamination between stocks and allow for ease of operation and consistency.
Propane-oxygen Torch: A mixture of propane and oxygen gas is directed through a Bernz-O-Matic flame nozzle to create a hot flame about ½ inch long. This torch is used to flame-seal the glass pipettes used in phase behavior experiments.
Convection Ovens: Several convection ovens are used to incubate the phase behaviors and core flood experiments at the reservoir temperatures. The phase behavior pipettes are primarily kept in Blue M and Memmert ovens that are monitored with mercury thermometers and oven temperature gauges to ensure temperature fluctuations are kept at a minimal between recordings. A large custom built flow oven was used to house most of the core flood experiments and enabled fluid injection and collection to be done at reservoir temperature.
pH Meter: An ORION research model 701/digital ion analyzer with a pH electrode is used to measure the pH of most aqueous samples to obtain more accurate readings. This is calibrated with 4.0, 7.0 and 10.0 pH solutions. For rough measurements of pH, indicator papers are used with several drops of the sampled fluid.

### Phase Behavior Calculations

The oil and water solubilization ratios are calculated from interface measurements taken from phase behavior pipettes. These interfaces are recorded over time as the mixtures approached equilibrium and the volume of any macroemulsions that initially formed decreased or disappeared.

### Phase Behavior Methodology

The methods for creating, measuring and recording observations are described in this section. Scans are made using a variety of electrolyte mixtures described below. Oil is added to most aqueous non-surfactant solutions to see if a microemulsion formed, how long it took to form and equilibrate if it formed, what type of microemulsion formed and some of its properties such as viscosity. However, the behavior of aqueous mixtures without oil added is also important and is also done in some cases to determine if the aqueous solution is clear and stable over time, becomes cloudy or separated into more than one phase.

Preparation of samples. Phase behavior samples are made by first preparing non-surfactant aqueous stock solutions and combining them with brine stock solutions in order to observe the behavior of the mixtures over a range of salinities.

Solution Preparation. Non-surfactant aqueous stock solutions are based on active weight-percent co-solvent. The masses of co-solvent, alkali agent and de-ionized water (DI) are measured out on a balance and mixed in glass jars using magnetic stir bars. The order of addition is recorded on a mixing sheet along with actual masses added and the pH of the final solution. Brine solutions are created at the necessary weight percent concentrations for making the scans.

Co-solvent Stock. The chemicals being tested are first mixed in a concentrated stock solution that usually consisted of co-solvent, alkali agent and/or polymer along with de-ionized water. The quantity of chemical added is calculated based on activity and measured by weight percent of total solution. Initial experiments are at about 1-3% co-solvent so that the volume of the middle microemulsion phase would be large enough for accurate measurements assuming a solubilization ratio of at least 10 at optimum salinity.

Polymer Stock. Often these stocks were quite viscous and made pipetting difficult so they are diluted with de-ionized water accordingly to improve ease of handling. Mixtures with polymer are made only for those co-solvent formulations that showed good behavior and merited additional study for possible testing in core floods. Consequently, scans including polymer are limited since they are done only as a final evaluation of compatibility with the co-solvent.

Pipetting Procedure. Phase behavior components are added volumetrically into 5 ml pipettes using an Eppendorf Repeater Plus or similar pipetting instrument. Co-solvent, alkali agent and brine stocks are mixed with DI water into labeled pipettes and brought to temperature before agitation. Almost all of the phase behavior experiments are initially created with a water oil ratio (WOR) of 1:1, which involves mixing 2 ml of the aqueous phase with 2 ml of the evaluated crude oil or hydrocarbon, and different WOR experiments are mixed accordingly. The typical phase behavior scan consisted of 10-20 pipettes, each pipette being recognized as a data point in the series.

Order of Addition. Consideration must be given to the addition of the components since the concentrations are often several folds greater than the final concentration. Therefore, an order is established to prevent any adverse effects resulting from co-solvent, alkali agent or polymer coming into direct contact with the concentrated electrolytes. The desired sample compositions are made by combining the stocks in the following order: (1) Electrolyte stock(s); (2) De-ionized water; (3) co-solvent stock; (4) alkali agent stock; (5) Polymer stock; and (6) Crude oil or hydrocarbon.

Initial Observations. Once the components are added to the pipettes, sufficient time is allotted to allow all the fluid to drain down the sides. Then aqueous fluid levels are recorded before the addition of oil. These measurements are marked on record sheets. Levels and interfaces are recorded on these documents with comments over several days and additional sheets are printed as necessary.

Sealing and Mixing. The pipettes are blanketed with argon gas to prevent the ignition of any volatile gas present by the flame sealing procedure. The tubes are then sealed with the propane-oxygen torch to prevent loss of additional volatiles when placed in the oven. Pipettes are arranged on the racks to coincide with the change in the scan variable. Once the phase behavior scan is given sufficient time to reach reservoir temperature (15-30 minutes), the pipettes are inverted several times to provide adequate mixing. Tubes are observed for low tension upon mixing by looking at droplet size and how uniform the mixture appeared. Then the solutions are allowed to equilibrate over time and interface levels are recorded to determine equilibration time and co-solvent/alkali agent performance.

Measurements and Observations. Phase behavior experiments are allowed to equilibrate in an oven that is set to the reservoir temperature for the crude oil being tested. The fluid levels in the pipettes are recorded periodically and the trend in the phase behavior observed over time. Equilibrium behavior is assumed when fluid levels ceased to change within the margin of error for reading the samples.

Fluid Interfaces. The fluid interfaces are the most crucial element of phase behavior experiments. From them, the phase volumes are determined and the solubilization ratios are calculated. The top and bottom interfaces are recorded as the scan transitioned from an oil-in-water microemulsion to a water-in-oil microemulsion. Initial readings are taken one day after initial agitation and sometimes within hours of agitation if coalescence appeared to happen rapidly. Measurements are taken thereafter at increasing time intervals (for example, one day, four days, one week, two weeks, one month and so on) until equilibrium is reached or the experiment is deemed unessential or uninteresting for continued observation.

### V. Embodiments

### Embodiment 1

An emulsion composition comprising a heavy crude oil, water and a co-solvent, wherein said co-solvent is an alkylamine or a compound having the formula:

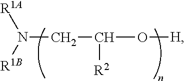

wherein
R^{1A} and R^{1B} are independently hydrogen, unsubstituted C₁-C₈ alkyl, unsubstituted cycloalkyl, unsubstituted heterocycloalkyl, unsubstituted aryl, unsubstituted heteroaryl, C₁-C₆ alkylamine or

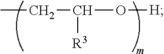

R² and R³ are independently hydrogen or unsubstituted C₁-C₂ alkyl; n is an integer from 1 to 30;
m is an integer from 1 to 30; and wherein said emulsion composition is within a petroleum reservoir.

### Embodiment 2

The emulsion composition of embodiment 1, wherein said compound has the formula:

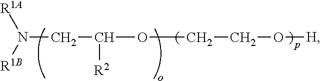

wherein R² is methyl or ethyl; o is an integer from 0 to 15; and p is an integer from 1 to 10.

### Embodiment 3

The emulsion composition of any one of embodiments 1, wherein said compound has the formula:

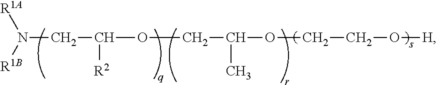

wherein R² is ethyl; q is an integer from 0 to 10; r is an integer from 0 to 10; and s is an integer from 1 to 10.

### Embodiment 4

The emulsion composition of any one of embodiments 1-3, wherein said alkylamine is diisopropylamine.

### Embodiment 5

The emulsion composition of any one of embodiments 1-4, wherein said alkylamine is an alkylpolyamine.

### Embodiment 6

The emulsion composition of embodiment 5, wherein said alkylpolyamine is dimethylaminopropylamine, triethylenetetramine or diethylenetriamine.

### Embodiment 7

The emulsion composition of any one of embodiments 1-6, further comprising an alkali agent.

### Embodiment 8

The emulsion composition of embodiment 7, wherein said alkali agent is the alkali agent is NaOH, KOH, LiOH, Na₂CO₃, NaHCO₃, Na-metaborate, Na silicate, Na orthosilicate, Na acetate or NH₄OH.

### Embodiment 9

The emulsion composition of any one of embodiments 1-8, further comprising an arylamine.

### Embodiment 10

The emulsion composition of embodiment 9, wherein said arylamine is aniline.

### Embodiment 11

The emulsion composition of any one of embodiments 1-10, further comprising a viscosity enhancing water soluble polymer.

### Embodiment 12

The emulsion composition of any one of embodiments 1-11, further comprising a gas.

### Embodiment 13

The emulsion composition of any one of embodiments 1-12, wherein said heavy crude oil has a viscosity of at least 100,000 cP.

### Embodiment 14

The emulsion composition of any one of embodiments 1-13, wherein said heavy crude oil has a viscosity of at least 200,000 cP.

### Embodiment 15

The emulsion composition of any one of embodiments 1-14, wherein said heavy crude oil has a viscosity of at least 300,000 cP.

### Embodiment 16

The emulsion composition of any one of embodiments 1-15, wherein said emulsion composition is a microemulsion.

### Embodiment 17

The emulsion composition of any one of embodiments 1-16, wherein the viscosity of said emulsion is lower than the viscosity of said heavy crude oil.

### Embodiment 18

The emulsion composition of any one of embodiments 1-17, wherein the viscosity of said emulsion is lower than the viscosity in the absence of said co-solvent.

### Embodiment 19

A non-surfactant aqueous composition comprising water and a co-solvent, wherein said co-solvent is an alkylamine or a compound having the formula:

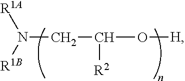

wherein R^{1A} and R^{1B} are independently hydrogen, unsubstituted C₁-C₈ alkyl, unsubstituted cycloalkyl, unsubstituted heterocycloalkyl, unsubstituted aryl, unsubstituted heteroaryl, C₁-C₆ alkylamine or

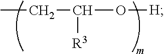

R² and R³ are independently hydrogen or unsubstituted C₁-C₂ alkyl; n is an integer from 1 to 30; and m is an integer from 1 to 30.

### Embodiment 20

The non-surfactant aqueous composition of embodiment 19, wherein R^{1A} and R^{1B} are independently unsubstituted C₁-C₆ alkyl.

### Embodiment 21

The non-surfactant aqueous composition of any one of embodiments 19-20, wherein the number of total carbon atoms within R^{1A} and R^{1B} combined does not exceed 8.

### Embodiment 22

The non-surfactant aqueous composition of any one of embodiments 19-21, wherein R^{1A} and R^{1B} are independently unsubstituted C₁-C₄ alkyl.

### Embodiment 23

The non-surfactant aqueous composition of any one of embodiments 19-22, wherein R^{1A} and R^{1B} are unsubstituted isopropyl.

### Embodiment 24

The non-surfactant aqueous composition of one of embodiments 19 to 23, wherein n is an integer from 1 to 10.

### Embodiment 25

The non-surfactant aqueous composition of one of embodiments 19 to 24, wherein n is an integer from 1 to 6.

### Embodiment 26

The non-surfactant aqueous composition of one of embodiments 19 to 25, wherein R² is hydrogen and n is an integer from 1 to 3.

### Embodiment 27

The non-surfactant aqueous composition of any one of embodiments 19-26, wherein m is an integer from 1 to 10.

### Embodiment 28

The non-surfactant aqueous composition of any one of embodiments 19-27, wherein m is an integer from 1 to 6.

### Embodiment 29

The non-surfactant aqueous composition of any one of embodiments 19-28, wherein R³ is hydrogen and m is an integer from 1 to 3.

### Embodiment 30

The non-surfactant aqueous composition of embodiment 19, wherein R^{1A} and R^{1B} are independently hydrogen or C₂-C₆ alkylamine.

### Embodiment 31

The non-surfactant aqueous composition of embodiment 30, wherein R^{1A} is hydrogen and R^{1B} is C₄-C₆ alkylamine.

### Embodiment 32

The non-surfactant aqueous composition of embodiment 19, wherein R^{1A} and R^{1B} are independently C₂-C₄ alkylamine.

### Embodiment 33

The non-surfactant aqueous composition of one of embodiments 30 to 32, wherein said alkylamine is an alkylpolyamine.

### Embodiment 34

The non-surfactant aqueous composition of embodiment 19, wherein R^{1A} is hydrogen and R^{1B} is unsubstituted cycloalkyl.

### Embodiment 35

The non-surfactant aqueous composition of embodiment 34, wherein R^{1B} is 6 membered cycloalkyl.

### Embodiment 36

The non-surfactant aqueous composition of embodiment 19, wherein R^{1A} is hydrogen and R^{1B} is unsubstituted aryl.

### Embodiment 37

The non-surfactant aqueous composition of embodiment 36, wherein R^{1B} is phenyl.

### Embodiment 38

The non-surfactant aqueous composition of embodiment 19, wherein said compound has the formula:

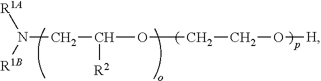

wherein R² is methyl or ethyl; o is an integer from 0 to 15; and p is an integer from 1 to 10.

### Embodiment 39

The non-surfactant aqueous composition of embodiment 38, wherein R² is hydrogen, o is 0 and p is an integer from 1 to 6.

### Embodiment 40

The non-surfactant aqueous composition of embodiment 19, wherein said compound has the formula:

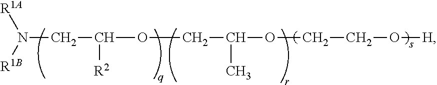

wherein R² is ethyl; q is an integer from 0 to 10; r is an integer from 0 to 10; and s is an integer from 1 to 10.

### Embodiment 41

The non-surfactant aqueous composition of embodiment 19, wherein said alkylamine is diisopropylamine.

### Embodiment 42

The non-surfactant aqueous composition of embodiment 19, wherein said alkylamine is an alkylpolyamine.

### Embodiment 43

The non-surfactant aqueous composition of embodiment 42, wherein said alkylpolyamine is dimethylaminopropylamine, triethylenetetramine or diethylenetriamine.

### Embodiment 44

The non-surfactant aqueous composition of embodiment 19, further comprising an alkali agent.

### Embodiment 45

The non-surfactant aqueous composition of embodiment 44, wherein said alkali agent is NaOH, KOH, LiOH, Na₂CO₃, NaHCO₃, Na-metaborate, Na silicate, Na orthosilicate, Na acetate or NH₄OH.

### Embodiment 46

The non-surfactant aqueous composition of embodiment 19, further comprising an arylamine.

### Embodiment 47

The non-surfactant aqueous composition of embodiment 46, wherein said arylamine is aniline.

### Embodiment 48

The non-surfactant aqueous composition of embodiment 19, further comprising a viscosity enhancing water soluble polymer.

### Embodiment 49

The non-surfactant aqueous composition of embodiment 48, wherein said viscosity enhancing water soluble polymer is polyacrylamide or a co-polymer of polyacrylamide.

### Embodiment 50

The non-surfactant aqueous composition of embodiment 19, further comprising a gas.

### Embodiment 51

A method of displacing an unrefined petroleum material comprising a heavy crude oil, wherein said unrefined petroleum material is in contact with a solid material, said method comprising:

(i) contacting an unrefined petroleum material comprising a heavy crude oil with a non-surfactant aqueous composition of one of embodiments 19 to 50, wherein said unrefined petroleum material is in contact with a solid material;
(ii) allowing said unrefined petroleum material to separate from said solid material thereby displacing said unrefined petroleum material in contact with said solid material.

### Embodiment 52

The method of embodiment 51, further comprising contacting said solid material with said non-surfactant aqueous composition.

### Embodiment 53

The method of embodiment 51, wherein said method is an enhanced oil recovery method.

### Embodiment 54

The method of embodiment 51, wherein said natural solid material is rock or regolith.

### Embodiment 55

The method of embodiment 54, wherein said regolith is soil.

### Embodiment 56

The method of embodiment 51, wherein an emulsion forms after said contacting.

### Embodiment 57

A method of converting an unrefined petroleum acid into a surfactant, said method comprising:

contacting a petroleum material with a non-surfactant aqueous composition of one of embodiments 19 to 50, thereby forming an emulsion in contact with said petroleum material;
(ii) allowing an unrefined petroleum acid within said unrefined petroleum material to enter into said emulsion, thereby converting said unrefined petroleum acid into a surfactant.

### Embodiment 58

The method of embodiment 57, wherein said unrefined petroleum material is in a petroleum reservoir.

### Embodiment 59

The method of embodiment 57, wherein said unrefined petroleum material comprises an active oil.

What is claimed is:

1. An emulsion composition comprising a heavy crude oil, water and a co-solvent, wherein said co-solvent is an alkylamine or a compound having the formula: 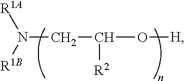
wherein
R^{1A} and R^{1B} are independently hydrogen, unsubstituted C₁-C₈ alkyl, unsubstituted cycloalkyl, unsubstituted heterocycloalkyl, unsubstituted aryl, unsubstituted heteroaryl, C₁-C₆alkylamine or 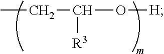
R² and R³ are independently hydrogen or unsubstituted C₁-C₂ alkyl;
n is an integer from 1 to 30;
m is an integer from 1 to 30; and
wherein said emulsion composition is within a petroleum reservoir.

2. The emulsion composition of claim 1, wherein said compound has the formula: 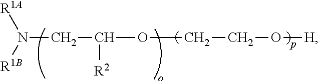
wherein
R² is methyl or ethyl;
o is an integer from 0 to 15; and
p is an integer from 1 to 10.

3. The emulsion composition of claim 1, wherein said compound has the formula: 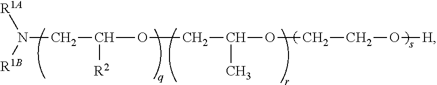
wherein
R² is ethyl;
q is an integer from 0 to 10;
r is an integer from 0 to 10; and
s is an integer from 1 to 10.

4. The emulsion composition of claim 1, wherein said alkylamine is diisopropylamine.

5. The emulsion composition of claim 1, wherein said alkylamine is an alkylpolyamine.

6. The emulsion composition of claim 1, further comprising an alkali agent.

7. The emulsion composition of claim 1, further comprising an arylamine.

8. The emulsion composition of claim 7, wherein said arylamine is aniline.

9. A non-surfactant aqueous composition comprising water and a co-solvent, wherein said co-solvent is an alkylamine or a compound having the formula: 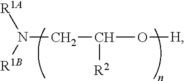
wherein
R^{1A} and R^{1B} are independently hydrogen, unsubstituted C₁-C₈ alkyl, unsubstituted cycloalkyl, unsubstituted heterocycloalkyl, unsubstituted aryl, unsubstituted heteroaryl, C₁-C₆alkylamine or 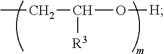
R² and R³ are independently hydrogen or unsubstituted C₁-C₂ alkyl;
n is an integer from 1 to 30; and
m is an integer from 1 to 30.

10. The non-surfactant aqueous composition of claim 9, wherein the number of total carbon atoms within R^{1A} and R^{1B} combined does not exceed 8.

11. The non-surfactant aqueous composition of claim 9, wherein R^{1A} and R^{1B} are unsubstituted isopropyl.

12. The non-surfactant aqueous composition of claim 9, wherein R² is hydrogen and n is an integer from 1 to 3.

13. The non-surfactant aqueous composition of claim 9, wherein R³ is hydrogen and m is an integer from 1 to 3.

14. The non-surfactant aqueous composition of claim 9, wherein R^{1A} is hydrogen and R^{1B} is C₄-C₆ alkylamine.

15. The non-surfactant aqueous composition of claim 9, wherein R^{1A} is hydrogen and R^{1B} is unsubstituted cycloalkyl.

16. The non-surfactant aqueous composition of claim 9, wherein R^{1B} is phenyl.

17. The non-surfactant aqueous composition of claim 9, wherein said compound has the formula: 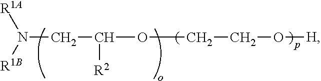
wherein
R² is methyl or ethyl;
o is an integer from 0 to 15; and
p is an integer from 1 to 10.

18. The non-surfactant aqueous composition of claim 9, wherein said alkylamine is diisopropylamine.

19. The non-surfactant aqueous composition of claim 9, further comprising an arylamine.

20. A method of displacing an unrefined petroleum material comprising a heavy crude oil, wherein said unrefined petroleum material is in contact with a solid material, said method comprising:
(i) contacting an unrefined petroleum material comprising a heavy crude oil with a non-surfactant aqueous composition of claim 9, wherein said unrefined petroleum material is in contact with a solid material;
(ii) allowing said unrefined petroleum material to separate from said solid material thereby displacing said unrefined petroleum material in contact with said solid material.
